(19) United States
(12) Patent Application Publication
(10) Pub. No.: US 2022/0092442 A1
(43) Pub. Date: Mar. 24, 2022

(54) SYSTEMS, METHODS, AND APPARATUSES FOR EVALUATING WAIT TIMES AND QUEUE LENGTHS AT MULTI-STATION AND MULTI-STAGE SCREENING ZONES VIA A DETERMINISITC DECISION SUPPORT ALGORITHM

(71) Applicant: Arizona Board of Regents on behalf of Arizona State University, Scottsdale, AZ (US)

(72) Inventors: Jorge Alberto Sefair Cristancho, Scottsdale, AZ (US); Ronald Askin, Phoenix, AZ (US); Girish Hanumantha, Tempe, AZ (US); Berkin Arici, New York, NY (US); Casin Corallo, Tempe, AZ (US); Troy Munson, Paradise Valley, AZ (US)

(21) Appl. No.: 17/481,120

(22) Filed: Sep. 21, 2021

Related U.S. Application Data
(60) Provisional application No. 63/081,026, filed on Sep. 21, 2020.

(51) Int. Cl. G06N 5/02; G06F 17/18; G06Q 10/04

(52) U.S. Cl. CPC G06N 5/02; G06Q 10/04; G06F 17/18

(57) ABSTRACT

In accordance with embodiments disclosed herein, there are provided herein systems, methods, and apparatuses for predicting and evaluating wait times and queue lengths at multi-station and multi-stage screening zones via a deterministic decision support algorithm and complementary prediction model. For example, there is disclosed in accordance with a particular embodiment, a specially configured Visual Analytics and Decision Support System platform (VADSS platform), having means by which to model, predict, and evaluate airport security wait times. Additionally described in accordance with various embodiments is a workforce allocation and configuration decision system for airport security checkpoints (e.g., number of lanes open) based on passenger volume forecasts. The accuracy of such forecasts is critical for the smooth functioning of security checkpoints where unexpected surges in passenger volumes are handled proactively. Thus, the described forecasting model combines flight schedules and other business fundamentals with historically observed throughput patterns to predict passenger volumes in a multi-terminal multi-security screening checkpoint airport. Additionally disclosed is an optimization model and a solution strategy for dynamically selecting a configuration of open screening lanes to minimize passenger queues and wait times that at the same time determine workforce allocations.

### CLAIM OF PRIORITY

This non-provisional U.S. Utility Patent Application is related to, and claims priority to the U.S. Provisional Patent Application No. 63/081,026, entitled “SYSTEMS, METHODS, AND APPARATUSES FOR EVALUATING WAIT TIMES AND QUEUE LENGTHS AT MULTI-STATION AND MULTI-STAGE SCREENING ZONES VIA A DETERMINISTIC DECISION SUPPORT ALGORITHM,” filed Sep. 21, 2020, having Attorney Docket Number 37864.649P (M20-242P\hat{ }-PR1), the entire contents of which is incorporated herein by reference as though set forth in full.

### GOVERNMENT RIGHTS AND GOVERNMENT AGENCY SUPPORT NOTICE

This invention was made with government support under 2017-ST-061-000101 awarded by the Department of Homeland Security. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to air-travel and transportation security logistics, and more particularly, to systems, methods, and apparatuses for evaluating wait times and queue lengths at multi-station and multi-stage screening zones via a deterministic decision support algorithm.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

In the United States, the traveling public must undergo various screening procedures with the intent of ensuring that no dangerous or prohibited items are carried into the public transportation system.

Such screening is typically conducted by the Transportation Security Administration (TSA), which is an agency of the U.S. Department of Homeland Security with authority over the security of the traveling public in the United States. While all modes of public transport fall within their scope of authority, the TSA is chiefly concerned with air travel, employing screening “officers” in airports, armed Federal Air Marshals on planes, as well as mobile teams of dog handlers and explosives specialists.

Notwithstanding the various systems utilized to process passengers, the sheer volume of individuals traveling through airport checkpoints continues to stress the system, leading to slowdowns, inefficiencies, and potential security risks due to the security agents becoming overwhelmed.

Improved systems are needed which provide insights into security screening processing times, predictive system throughput, and actionable operational policies, data, and recommendations. Unfortunately, present systems lack the ability to provide useful predictive analytics in an intuitively understood presentation. Therefore, disclosed herein are integrated systems that provide actionable operational recommendations as to the number of Travel Document Check (TDC) stations and screening lanes needed at any given time to achieve a desired quality of service (such as a desired maximum of 10-minute wait times, etc.). These configurations are then translated into staffing needs and workforce allocation decisions.

Transportation security screeners around the world, and especially domestic TSA security screeners are therefore likely to benefit from the systems, methods, and apparatuses for evaluating wait times and queue lengths at multi-station and multi-stage screening zones via a deterministic decision support algorithm, as described herein.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1A depicts an exemplary interface of the decision support system having specifically implemented the specialized algorithm, in accordance with described embodiments;

FIG. 1B depicts another exemplary interface of the decision support system having specifically implemented the specialized algorithm, in accordance with described embodiments;

FIG. 1C depicts another exemplary interface of the decision support system having specifically implemented the specialized algorithm, in accordance with described embodiments;

FIGS. 1D and 1E depict additional exemplary interfaces provided by the decision support system having specifically implemented the specialized algorithm, in accordance with described embodiments;

FIGS. 1F and 1G depict additional exemplary interfaces provided by the decision support system having specifically implemented the specialized algorithm, in accordance with described embodiments;

FIGS. 1H and 1I depict additional exemplary interfaces provided by the decision support system having specifically implemented the specialized algorithm, in accordance with described embodiments;

FIGS. 1J and 1K depict additional exemplary interfaces provided by the decision support system having specifically implemented the specialized algorithm, in accordance with described embodiments;

FIG. 2 depicts an exemplary computing architecture upon which the VADSS platform may operate, in accordance with described embodiments;

FIGS. 3A, 3B, and 3C depict parameter tuning and observed projections versus reality for the model for improving airport security operations, in accordance with described embodiments;

FIG. 3D depicts Table 0, which provides a more detailed description of the publicly available data sources, according to described embodiments;

FIG. 3E depicts Table 1, which shows the MAE for the mechanistic, adjusted, and TSA predictions against observed throughput, according to described embodiments;

FIG. 3F depicts Table 2, which shows that the ensemble model has the smallest average underestimation error for SSCP A (element 305A), accounting for a relative error of 7.6% of the passenger volume at busy times, according to described embodiments;

FIG. 3G depicts Table 3, which shows that the TSA prediction model performs better than the mechanistic and adjusted models for both SSCPs A (element 305A) and B (element 305B), according to described embodiments;

FIG. 311 depicts Table 4, which shows the model performance when passenger arrivals are underestimated, where the best performance is given by the ensemble model for SSCP A (element 305A) and the mechanistic model for SSCP B (element 305B), according to described embodiments;

FIG. 4 depicts the performance of the ensemble model, in accordance with described embodiments;

FIG. 5 depicts the optimal configuration of each SSCP at the end of Stage 4, in accordance with described embodiments;

FIG. 6 depicts a graph indicating the optimal starting time and number of flexible TSOs allocated to the SSCP as well as the predicted passenger arrivals, in accordance with described embodiments;

FIG. 7 depicts charts showing the queue lengths at the end of Stage 1 and Stage 4 of each SSCP at the end of Stage 4, in accordance with described embodiments;

FIG. 8 depicts charts comparing the maximum wait time (i.e., K*-values) at the end of Stages 1 and 2, in accordance with described embodiments;

FIG. 9 depicts charts indicating the optimal SSCP configurations after imposing the operational constraints at equations (21)-(24), in accordance with described embodiments;

FIG. 10 illustrates a diagrammatic representation of a machine in the exemplary form of a computer system, in accordance with one embodiment;

FIGS. 11A and 11B depict flow diagrams illustrating a method for evaluating wait times and queue lengths at multi-station and multi-stage screening zones via a deterministic decision support algorithm, in accordance with disclosed embodiments; and

FIGS. 12A and 12B depict flow diagrams illustrating a method for computing passenger arrival estimations and optimal Transportation Security Officer (TSO) allocation within a multi-station and multi-stage security screening area having a plurality of Security Screening Checkpoints (SSCPs), in accordance with disclosed embodiments.

### DETAILED DESCRIPTION

Described herein are systems, methods, and apparatuses for evaluating wait times and queue lengths at multi-station and multi-stage screening zones via a deterministic decision support algorithm. For example, there are various embodiments described in greater detail below, including, for example, a Visual Analytics and Decision Support System platform (VADSS platform), including: a memory to store instructions; a processor to execute instructions stored in the memory; a parameter input interface to receive observed wait times and queue lengths at multi-station and multi-stage screening zones; a configuration interface to receive user specified configuration selections for processing the wait times and queue lengths; an analytical model to apply a specialized algorithm to yield future predicted wait times and queue lengths at the multi-station and multi-stage screening zones based at least in part on the observed wait times and queue lengths and the user specified configuration selections; in which the processor executes the instructions stored in the memory to cause the analytical model to accept the observed wait times and queue lengths as initial starting conditions and to incrementally update queue lengths at each stage to the start of the next period by adding any arrivals during a previous period and subtracting throughput for the respective stage based on the number of customers served; and in which the processor executes the instructions stored in the memory to cause the analytical model to further sequentially process each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and in which the processor executes the instructions stored in the memory to cause the analytical model to further compute and output the predicted wait time for any passenger by progressing that passenger on a first-come first-served manner through the network of service queues affiliated with each of the multi-station and multi-stage screening zones.

Designed for a system that performs security screening for arriving “passengers,” described embodiments present a system which utilizes a specialized algorithm for converting passenger arrival forecasts and proposed staffing levels at Security Screening Checkpoints (SSCPs) into estimates of queue lengths and wait times for those arriving passengers.

According to particular embodiments, such an algorithm is applied specifically to the multistage screening operations of passengers at airport checkpoints that pass through Travel Document Check (TDC) stations and Baggage Screening/X-ray screening stations.

A supporting “decision support system” specifically implementing the algorithm may further provide visual analytics based on actual performance as well as support hypothetical “What-if” investigations in support of the security screening operations and personnel.

Additionally described in accordance with various embodiments is a workforce allocation and configuration decisions at airport security checkpoints (e.g., number of lanes open) are usually based on passenger volume forecasts. The accuracy of such forecasts is critical for the smooth functioning of security checkpoints where unexpected surges in passenger volumes are handled proactively. Thus, described herein is a forecasting model that combines flight schedules and other business fundamentals with historically observed throughput patterns to predict passenger volumes in a multi-terminal multi-security screening checkpoint airport. Additionally presented is an optimization model and a solution strategy for dynamically selecting a configuration of open screening lanes to minimize passenger queues and wait times that at the same time determine workforce allocations. A real-world case study is further described, as experimentally tested at a U.S. airport to demonstrate the efficacy of the proposed models.

Such embodiments provide means by which to predict the number of passengers arriving at airport security screening checkpoints (SSCPs) for screening prior to boarding a commercial flight and then to allocate available Transportation Security Officers (TSOs) to minimize passenger wait times while complying with security protocols. The system models Travel Document Checking (TDC) and Baggage Screening for both Precheck and Standard lanes. The procedure fuses data from multiple public sources and uses those in a mechanistic and machine learning model to estimate arrivals. Those estimates are then used in an optimization algorithm to allocate the available TSOs to SSCPs over time to minimize queue lengths and wait times.

Described embodiments apply to the operational analysis (industrial engineering) field of airport security operations. The methodology used includes process analysis and data science. Developments include a procedure for fusing data from diverse sources, integrating statistical and machine learning techniques to produce arrival forecasts and the development of an optimization model and solution procedure.

These benefits are attained through the involves fusing of data from multiple sources, performing algebraic, statistical and artificial intelligence procedures on that data and then combining those results to obtain a more accurate prediction of the time-dependent arrivals of passengers to security screening checkpoints (SSCPs) at an airport. Input sources include federal aviation documents such as the T-100 report and a commercial program (OAG) containing flight schedules. The analysis includes a logic-based mechanistic modeling approach to first estimate base passenger arrival numbers. Machine learning is then used to adjust the estimates based on historical data for day of week, week of year and time of day. Finally, the estimates are combined with a time series analysis model built on historical data. Tests on actual data indicated the integrated ensemble method reduced estimation error. Those forecasts are then combined with data on the number of available TSOs per time interval to allocate TSO teams to open TDC and Baggage Screening lanes in PreCheck and Standard lines to minimize passenger queue lengths and wait times.

Notably, there is provided a more accurate algorithm and model for estimating passenger arrivals. The proposed method is distinguished by its integrated use of mechanistic modeling, machine learning and time series modeling to develop an improved ensemble estimate. The innovation is in the way the set of multiple inputs and modeling technologies are combined to create an improved estimator. Further provided is an optimization model used to assign TSOs to TDC and baggage checking lines to screen passengers on a dynamic basis to best process arrivals. The disclosed methodologies provide more accurate predictions of passengers arriving for screening at security checkpoints as well as providing a prescriptive solution for opening screening lanes. This prescriptive approach allows for active queue management as opposed to the current reactive approach, thus allowing supervisors to assign officers to checkpoint locations in advance of queue buildups to reduce wait times for passengers. In addition, the system allows supervisors to perform “What-if” analyses to determine the effect of proposed TSO allocation decisions or to quickly recover from unexpected events.

According to particular embodiments, the algorithmic methods for passenger arrival forecasting and TSO allocation may optionally be embedded into a professional quality decision support system to guide planning at all airports. In addition, the optimization methodology may be used by other agencies or industrial organizations faced with processing inputs through a multistage, parallel processor, serial network of service operations.

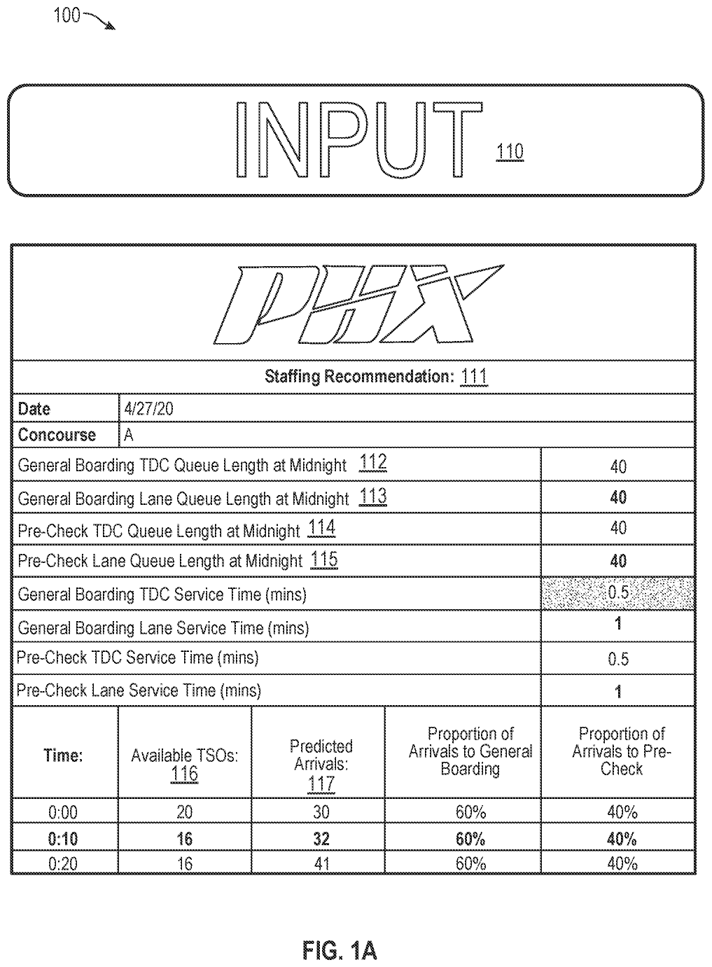

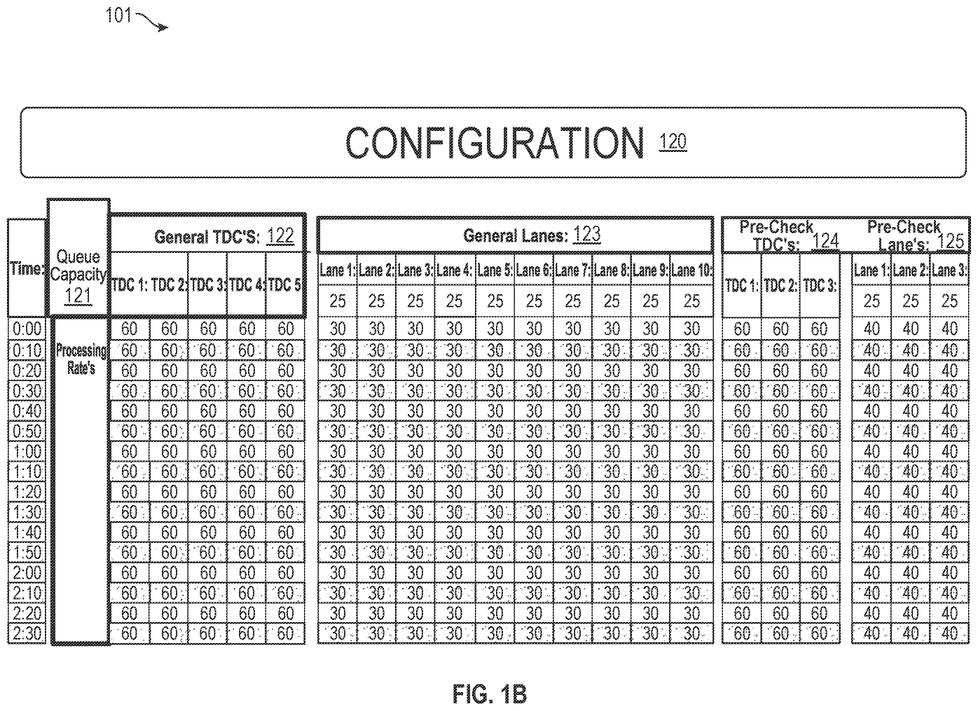

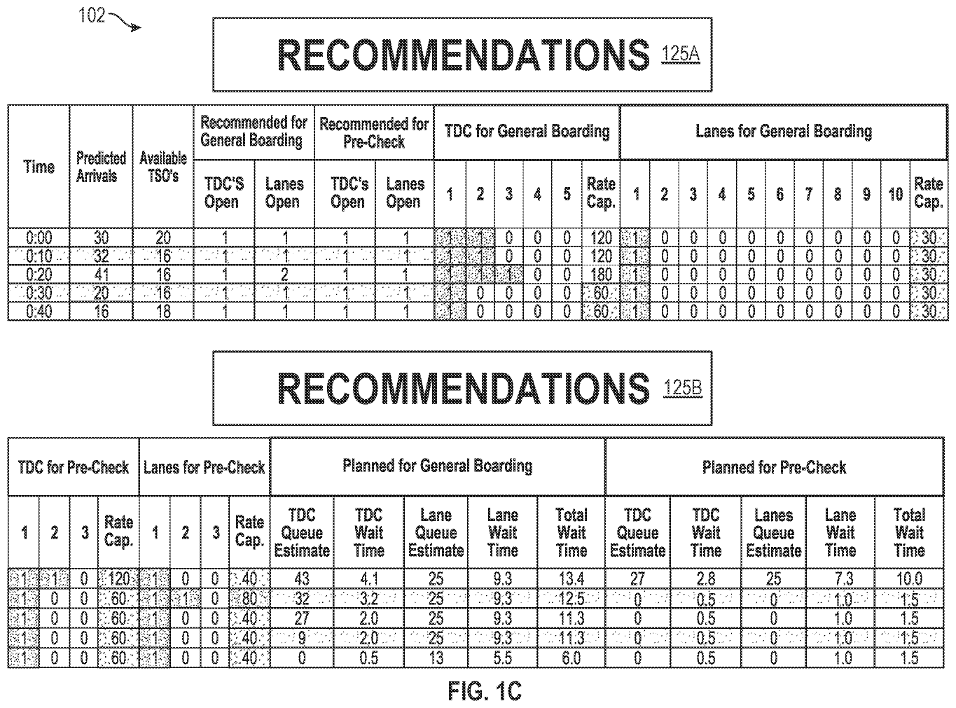

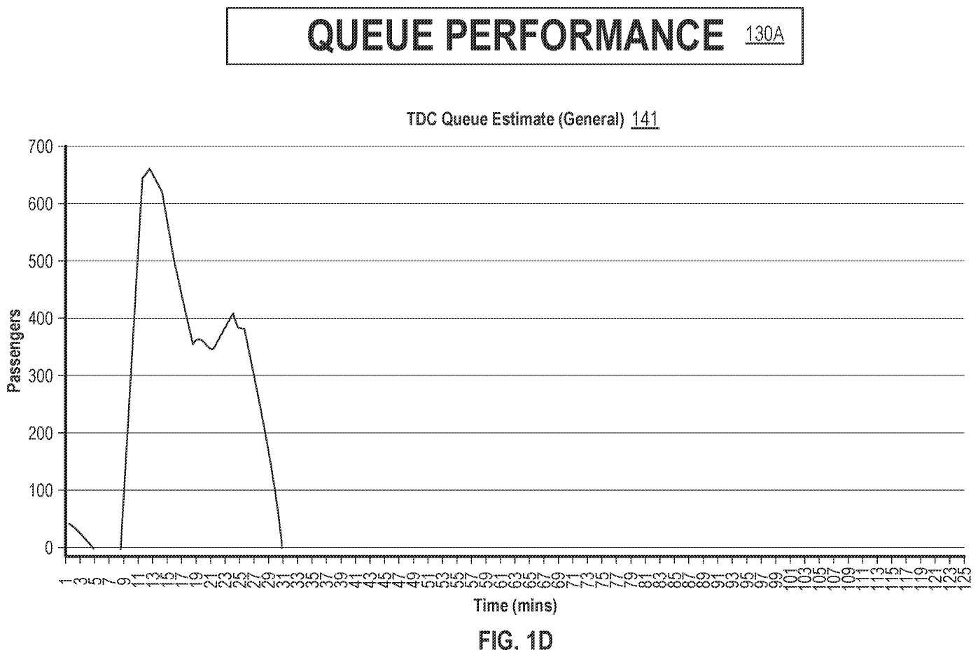

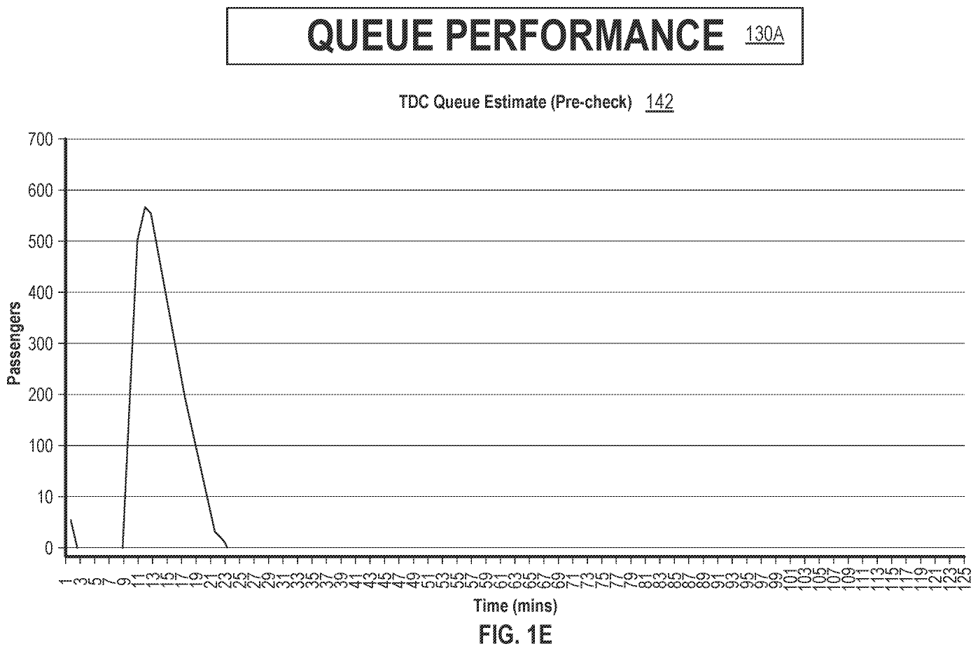

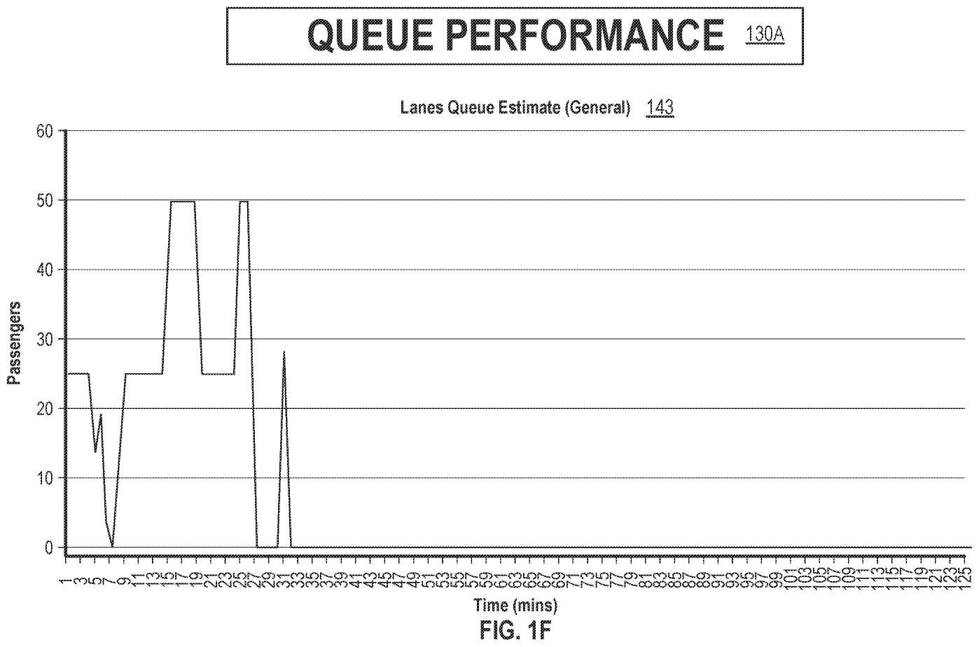

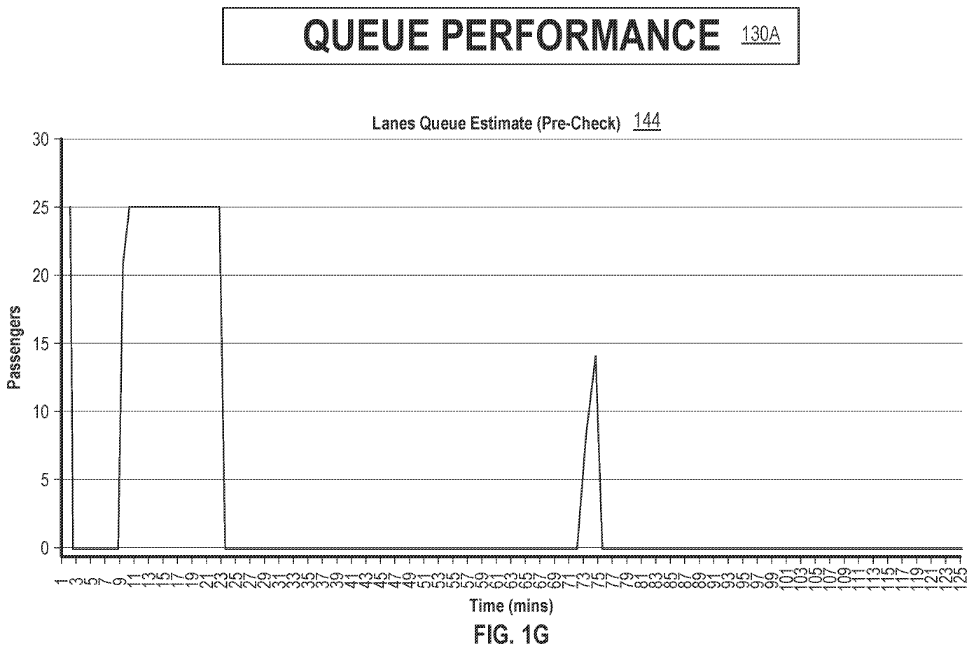

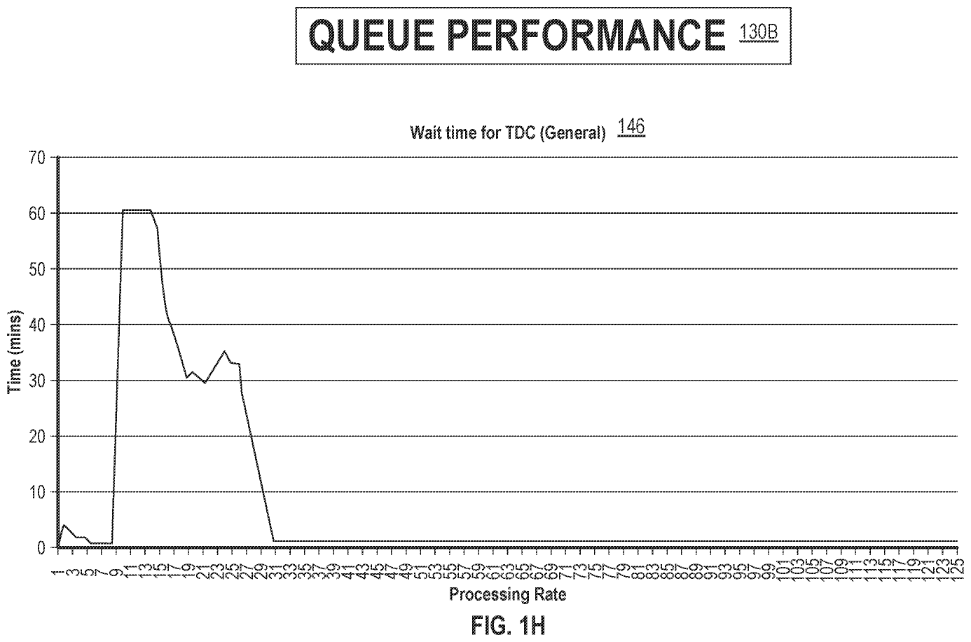

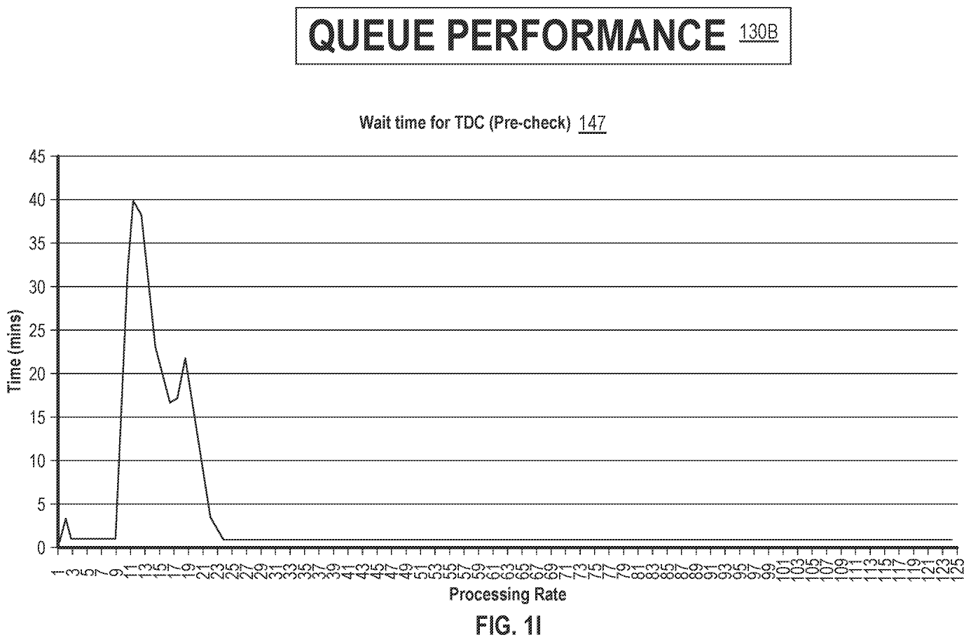

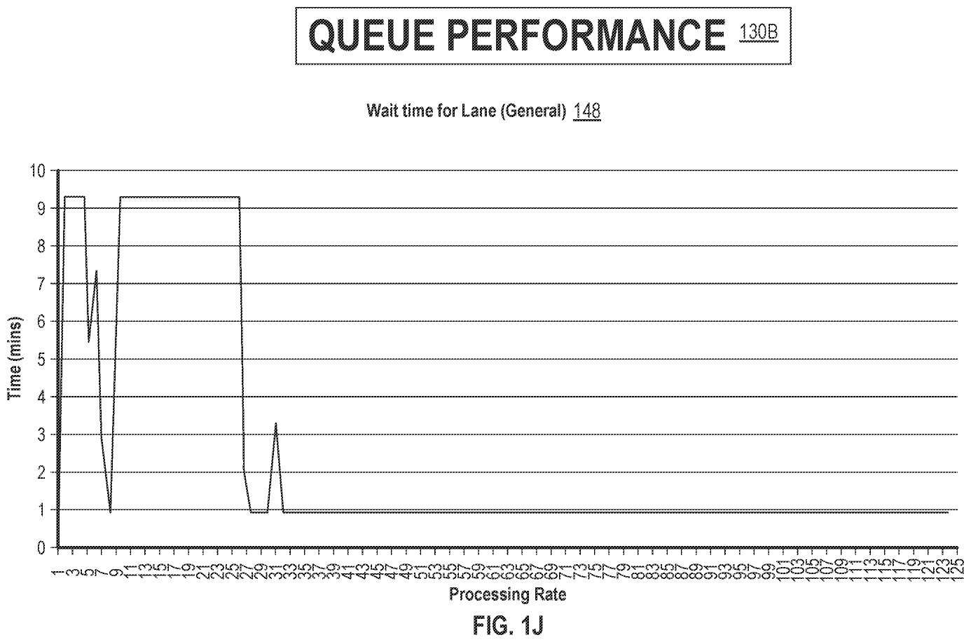

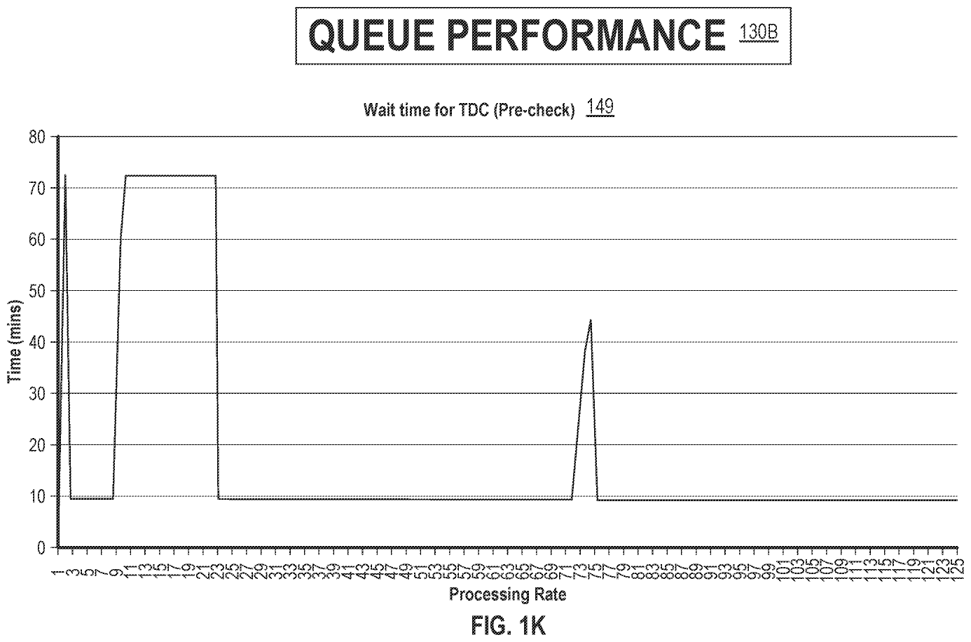

FIG. 1A depicts an exemplary interface 100 of the decision support system having specifically implemented the specialized algorithm, in accordance with described embodiments.

In particular, as may be observed here, an input 110 interface provided to security screener personnel permits for the entry of actual in-situ data into the decision support system, or in certain embodiments, the input interface 110 depicts the data automatically retrieved from available networked sources which is then utilized, analyzed, and otherwise consumed by the decision support system so as to then yield specific staffing recommendations 111.

As shown here, staffing recommendations are based on the inputs provided for “Concourse A” in which there are various input fields which may be automatically populated or manually populated, such as the general boarding TDC queue length at midnight 112, the general boarding lane queue length at midnight 113, the pre-check TDC queue length at midnight 114, the pre-check lane queue length at midnight 115, etc.

At the bottom section of the input interface 110 there are further provided fields for entry of the number of available TSOs (Transportation Security “Officers”) at element 116, predicted arrivals 117, etc.

The interfaces of the decision support system provide intuitive dashboards that assist security analysts in making staffing decisions at security checkpoints. The exemplary data depicted here is based on experiments conducted at Phoenix Sky Harbor Airport.

The “Visual Analytics and Decision Support System” (referred to herein as the “VADSS” or “VADSS platform” or “VADSS system”) consists of four tabs. Specifically, the input interface 110 tab described above, a configuration interface tab (refer to FIG. 1B at element 120), a recommendations interface tab (refer to FIG. 1C at element 125A and 125B), and a queue performance interface tab (refer to FIG. 1D and FIG. 1E at element 130A and 130B, respectively).

Using passenger arrival data and TSO availability, the VADSS platform dashboard displays the recommended checkpoint configuration as well as the predictive queue estimates and wait times.

The VADSS platform is designed to improve the prediction tools currently in place at TSA checkpoints presently deployed around the country. The VADSS platform allows users to test staffing configurations (e.g., by applying “what if” hypothetical configurations to the analytical model) that may dramatically reduce queues at security checkpoints and improve airport screening operations, thus ultimately contributing to improved safety and reduced inconvenience for the traveling public.

Such a system thus equips TSA analysts with quantitative tools to improve the performance of the security checkpoints, which will improve the passenger experience. Moreover, the VADSS platform is highly scalable and deployable to other airports throughout the world with limited modifications.

FIG. 1B depicts another exemplary interface 101 of the decision support system having specifically implemented the specialized algorithm, in accordance with described embodiments.

In particular, the above mentioned configuration interface 120 tab is shown here, in which there are multiple configurable options, including, for example, the queue capacity 121, general Travel Document Check (TDC) stations 122, general lanes, pre-check TDCs 124, and pre-check lanes 125.

While the VADSS platform is readily applicable to passenger screening at airport Security Screening CheckPoints (SSCPs) as described herein, it is equally applicable to all service organizations with predictable time-varying arrivals, including security checkpoints utilized by other transport modalities (e.g., train, ferry, etc.), with a serial flow of passengers through a finite set of multistage, parallel processing stations, each such station similarly having a finite, schedulable number of servers. Further still, the VADSS may be utilized at any other government screening facility such as U.S. Customs and Border Protection border crossings or TSA stations at international arrival locations, etc.

The VADSS platform provides an intuitive analytical tool and interface that assists security personnel with planning the allocation of employees needed to staff operating stations in a network of workstations where arriving demand and processing loads are dynamic and in which workstations require teams of workers.

There is a need for modeling the performance of the overall security apparatus with respect to queue lengths and throughput times for any given arrival rate and worker allocation to workstations, and yet, no suitable solution is available to the marketplace today.

The VADSS platform leverages analytical techniques from the fields of operational analysis (e.g., specifically within the field of industrial engineering) with the particular motivation of improving security operations for the traveling public and for the security officers which serve them. The VADSS platform provides thus employs further analytical techniques based upon dynamic process flow analysis, input-output analysis, and visual analytics, so as to generate and output superior predictive results.

FIG. 1C depicts another exemplary interface 102 of the decision support system having specifically implemented the specialized algorithm, in accordance with described embodiments.

Further depicted here is the recommendations interface tabs at elements 125A and 125B, which present outputs from the VADSS platform pursuant to processing of input data from the input interface (refer to FIG. 1A) and analytical processing in consideration of user controllable configuration parameters (refer to FIG. 1B). The recommendation interface tab may present actual recommendations based on actual data analyzed and consumed by the model or may present hypothetical recommendations in the event “what if” scenarios are being explored by the VADSS platform users.

VADSS platform provides an algorithmic approach for converting a dynamic stream of customer arrivals and planned staffing levels for a multistage, parallel processor, finite queue, serial flow network into estimates of queue lengths and throughput times at each processing stage at each point in time. The algorithm is deterministic providing point estimates. It assumes a first-come, first-service queue discipline.

For dynamic network configurations as described above, VADSS platform includes at least the following considerations: 1) a defined methodology for converting a dynamic forecast of expected arrivals and staffing levels into forecasts of queue lengths that will occur at each stage; 2) a defined means for converting those queue length estimates into estimated throughput (waiting) times at each stage and throughput time for the entire system for customers arriving any point in time; and 3) a set of tabular and graphical interface displays accompanied by a parameter input specification format (e.g., refer to the input interface 110 at FIG. 1A) for conveying system performance and guiding “What if” analysis exploration by analysts for improving future system performance.

According to disclosed embodiments, the VADSS platform applies a specialized algorithm which uses discrete time periods, nominally set to ten minute intervals, but these intervals are variable based on user preferences and configuration settings (e.g., refer to the configuration interface 120 tab at FIG. 1B).

When the VADSS platform is given the starting conditions, queue lengths at each stage are incrementally updated to the start of the next period by adding the arrivals during the previous period and subtracting the throughput for that stage (number of customers served).

According to certain embodiments, the specialized algorithm implemented by the VADSS platform operates sequentially through the serial stages of the network and computes the number served at each stage during the time interval as the minimum of the service capacity based on the number of service stations open and the user specified service rate per station, the number of initial customers in queue plus those arriving, and the service rate of the subsequent workstation in the event that the subsequent station buffer space (e.g. space between TDC and x-ray stations) is full.

According to disclosed embodiments, the VADSS platform further computes the wait time for any passenger by progressing that passenger in a first-come first-served manner through the network of service queues. Probabilistic visits to workstations such as secondary screening is optionally added and processed by the VADSS platform if desired and configured by the user via the configuration interface 120 (refer to FIG. 1B). The queue in front of any arriving customer at any stage (workstation) is reduced each time period based on that stage's effective processing rate (see #1 above) until the time interval in which the passenger's leading queue reaches zero. The VADSS platform further applies interpolation within the last period to determine the final throughput time, thus providing an approximation similar to a fluid flow model.

The resulting approximations generated by the VADSS platform are most applicable when arrival rates and server utilizations are sufficiently high such that the queue is rarely empty and servers are generally busy.

According to disclosed embodiments, the VADSS platform, utilizes the deterministic input-output analysis for the base or default modeling approach to determine the performance measures of interest.

According to disclosed embodiments, the VADSS platform further sums the wait times for each stage in the system multiplied by the probability of visiting that station. For instance, some passengers will be required to undergo secondary screening either at random or subject to manual intervention, such as a passenger's luggage being identified as suspect during x-ray inspection.

Secondary inspection is a separate stage and the VADSS platform uses a probability for this inspection even though the additional wait time is small. The limited buffer space between stages such as the TDC and x-ray screening is used by VADSS platform to throttle the TDC processing rate when the x-ray queue reaches the space capacity. Thus actual TDC processing rate for a time interval is the minimum of its initial queue occupation and arrivals in that interval from either external sources on internal network transfers or its processing capacity based on the number of servers and the x-ray processing rate based on the number of lanes open if the buffer space is full.

FIGS. 1D and 1E depict additional exemplary interfaces provided by the decision support system having specifically implemented the specialized algorithm, in accordance with described embodiments.

For instance, FIG. 1D shows a queue performance interface tab at element 130A having the Travel Document Check (TDC) queue estimate for general boarding at graph 141. The scale on the horizontal axis represents the queue time in minutes whereas the vertical axis represents the number of passengers at that given queue time. Thus, there is a peak of queued “general” passengers at approximately the 13 minute mark followed by a lesser peak around the 27 minute mark.

Similarly, FIG. 1E shows the TDC queue estimate for pre-check passengers at graph 142. As before, the scale on the horizontal axis representing the queue time in minutes whereas the vertical axis represents the number of passengers at that given queue time. Thus, there is a peak of queued “pre-check” passengers at approximately the 13 minute mark.

FIGS. 1F and 1G depict additional exemplary interfaces provided by the decision support system having specifically implemented the specialized algorithm, in accordance with described embodiments.

For instance, FIG. 1F shows a queue performance interface tab at element 130A having the lanes queue estimate for general boarding at graph 143. Again, the scale on the horizontal axis represents the queue time in minutes whereas the vertical axis represents the number of passengers at that given queue time. Thus, there is an estimated peak of approximately 50 queued “general” passengers for the lanes queue estimate at the 17 to 19 minute mark followed by a second peak of approximately 50 estimated general passengers at the 27 minute mark. While the prior graphs depict performance, the estimate graphs depicts the expected performance predicted in advance by the algorithm.

At FIG. 1G there is further depicted the queue performance interface tab at element 130A having the lanes queue estimate for “pre-check” boarding at graph 144. Again, the scale on the horizontal axis represents the queue time in minutes whereas the vertical axis represents the number of passengers at that given queue time. Thus, there is an estimated peak of approximately 25 queued “pre-check” passengers for the lanes queue estimate at the 9 minutes through 23 minutes mark followed by a second peak of approximately 14 estimated pre-check passengers later on at the 74 minute mark, as predicted in advance by the algorithm.

FIGS. 1H and 1I depict additional exemplary interfaces provided by the decision support system having specifically implemented the specialized algorithm, in accordance with described embodiments.

For instance, FIG. 1H shows a queue performance interface tab at element 130B having the “Wait Time” for Travel Document Check (TDC) for general boarding at graph 146. Distinct from before, the scale on the horizontal axis now represents the processing rate in terms of the quantity of passengers whereas the vertical axis represents the wait time in minutes. Thus, there is a peak wait time of approximately 61 minutes when the processing rate is approximately 11-15 passengers for the “general” TDC.

Similarly, FIG. 1I shows a queue performance interface tab at element 130B having the “Wait Time” for Travel Document Check (TDC) for “pre-check” passengers at graph 147. Again, the scale on the horizontal axis represents the processing rate in terms of the quantity of passengers whereas the vertical axis represents the wait time in minutes. Here the peak wait time is approximately 40 minutes when the processing rate is approximately 11-17 passengers awaiting “pre-check” Travel Document Check (TDC) procedures.

FIGS. 1J and 1K depict additional exemplary interfaces provided by the decision support system having specifically implemented the specialized algorithm, in accordance with described embodiments.

For instance, FIG. 1J shows a queue performance interface tab at element 130B having the “Wait Time for Lane” for general boarding at graph 148. As before, the scale on the horizontal axis represents the processing rate in terms of the quantity of passengers whereas the vertical axis represents the wait time in minutes. Thus, there is a peak wait time of over 9 minutes when the processing rate is 3-5 passengers followed by a second peak wait time of over 9 minutes when the processing rate is 9-27 passengers.

Similarly, FIG. 1K shows a queue performance interface tab at element 130B having the “Wait Time” for Travel Document Check (TDC) for “pre-check” passengers at graph 149. Again, the scale on the horizontal axis represents the processing rate in terms of the quantity of passengers whereas the vertical axis represents the wait time in minutes. Here the peak wait time is approximately 72 minutes when the processing rate is approximately 7-23 passengers awaiting “pre-check” Travel Document Check (TDC) procedures.

In such a way, the VADSS platform provides overall security apparatus and system performance through tabular and graphical outputs. In addition to displaying forecasted customer (passenger) arrival rates, planned staffing schedule and individual workstation productivities, the queue performance interface 130A-B display tabs show predicted queue lengths and wait times at each stage and for the overall security system at fixed time intervals.

Users of the VADSS platform have the further ability to change input parameters in real time to see the impact on performance measures via the input configuration interface tabs. Users of the VADSS platform may further determine the impact of specific staff and equipment scheduling policies by allowing individual servers at workstations or service lanes that require a team of workers to be turned on or off or vary in throughput rate over time as hypothetical “what if” scenarios within the VADSS platform, without having to actually risk implementing such changes to the security staffing levels and workstations without knowing in advance the predicted outcome.

According to such embodiments, the VADSS platform takes a forecasted input stream of customer arrivals to a multistage processing system and converting that stream into predicted wait times and queue lengths at each stage for systems with multiple parallel servers and finite queue space at each stage. The VADSS platform uses a deterministic input-output model for processing arriving customers in a first-come, first-served protocol. Customer routes are assumed known and unidirectional through the network of service stations but may have non-binary probabilities of visiting each workstation. The VADSS platform's analytical evaluator can be parameterized to determine the effect of different routes, staffing levels and server efficiencies.

Further still, the VADSS platform provides visual analytics in tabular and graphical form with user friendly parameter input options for exploring the effect on performance of alternative staffing, workstation productivity rates and customer arrival patterns.

Through such innovations, the VADSS platform is enabled to convert a dynamic customer arrival forecast into a dynamic, customer-specific expected wait time for a given service plan as well as permit the exploration of user-driven hypothetical optimizations to develop improved service plans, or even to test the impact of new service technologies before fully deploying such solutions at scale.

Because the VADSS platform employs a deterministic evaluation algorithm, the VADSS platform is capable of evaluating large systems over an extended time period quickly as opposed to stochastic digital simulation models.

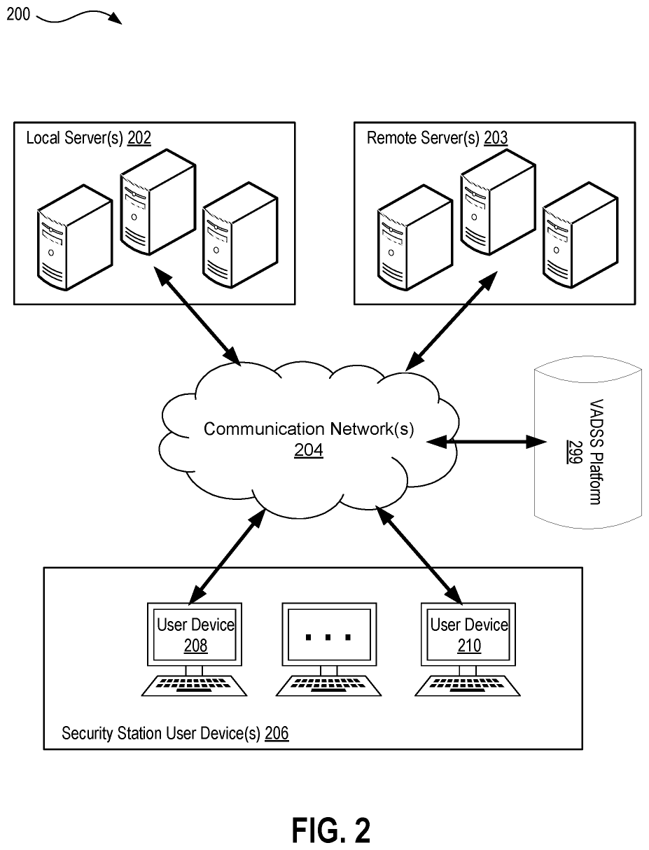

FIG. 2 depicts an exemplary computing architecture 200 upon which the VADSS platform may operate, in accordance with described embodiments.

In particular, there is depicted here, both local servers 202 from which input data may automatically be retrieved and entered into the VADSS platform or which may track localized data on behalf of the VADSS platform. For example, different airports around the world may elect to track and store certain types of information locally or may already have systems which track and store such information locally, and thus, such data may be retrieved from the local repository at the local servers 202 and input into the VADSS platform.

Similarly, there are remote servers 203 depicted, which may take the form of cloud based remote storage or may take the form of remotely located client-server repositories. For example, the TSA security personnel may have access to data stored by the Department of Homeland Security (DHS) which may be utilized by the VADSS platform by having the VADSS platform automatically retrieve and consume such data so as to fine-tune or to further enhance the predictive outcomes generated by the analytical model and execution of the specialized algorithm as applied via the VADSS platform 299.

Still further depicted are the security station user devices 206 which communicate with the VADSS platform 299 and with the local and remote servers (202-203) via the communications network 204. For example, user device 208 may be located at a Travel Document Check (TDC) station, whereas user device 210 may be located at an X-ray screening station, etc.

Advantageously, implementation of the VADSS platform 299 permits the rapid ability to predict performance for a given dynamic assignment plan of servers or to suggest a plan that will minimize wait times or queue lengths. In addition, the VADSS platform 299 allows easy customization for addressing hypothetical and “What-if” questions by varying input parameters under user control. No other solution available to the marketplace today provides the capabilities made available by the VADSS platform 299.

The VADSS platform 299 provides significant potential advantages to the TSA and CBP components of DHS that operate multistage screening procedures for passengers at airports and ports of entry. In addition, the VADSS platform 299 may further benefit other organizations that process customers through multistage operations with parallel servers as such entities will similarly the capabilities provided by the VADSS platform 299 useful, assuming such entities also have predictable time-varying arrival rates that are sufficiently large to allow high utilization of a finite set of servers and customer wait times. For instance, the VADSS platform 299 may prove beneficial to entities such as, by way of example, U.S. Post Office branches, DMV offices, and a variety of other government and non-government service organizations.

In such a way, the VADSS platform as described herein improves the prediction tools currently in use by security personnel at relevant multi-station and multi-stage screening zones across the country by predicting relevant and useful queue time and service estimates as well as by permitting users to test staffing configurations that can dramatically reduce queues at security checkpoints, each of which will drastically improve airport screening operations and enhance the safety of travelers across the globe.

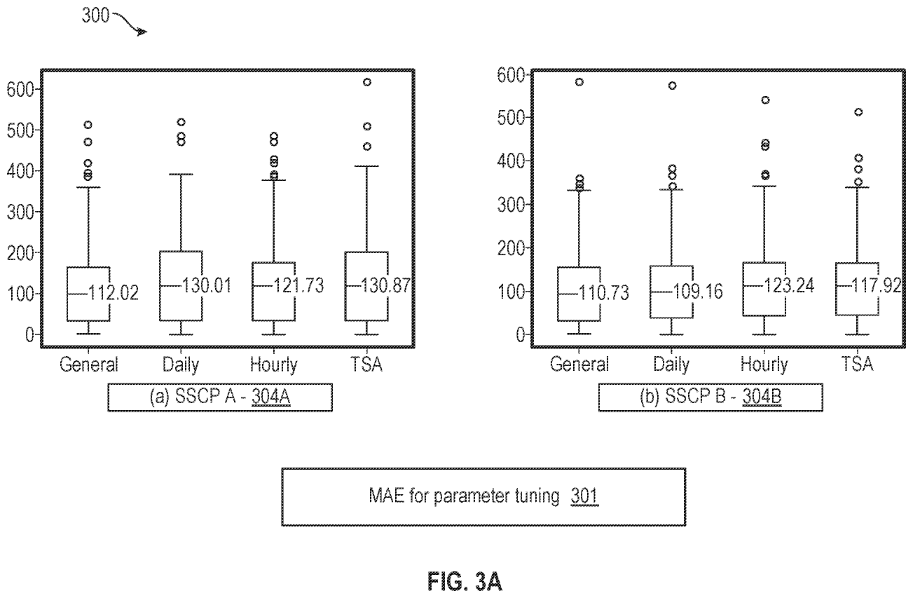

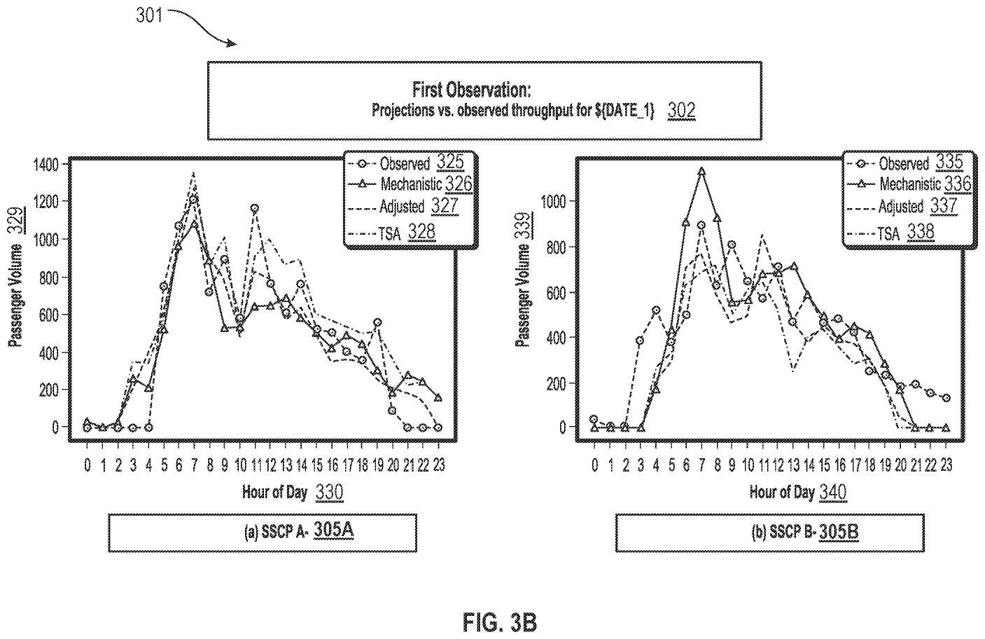

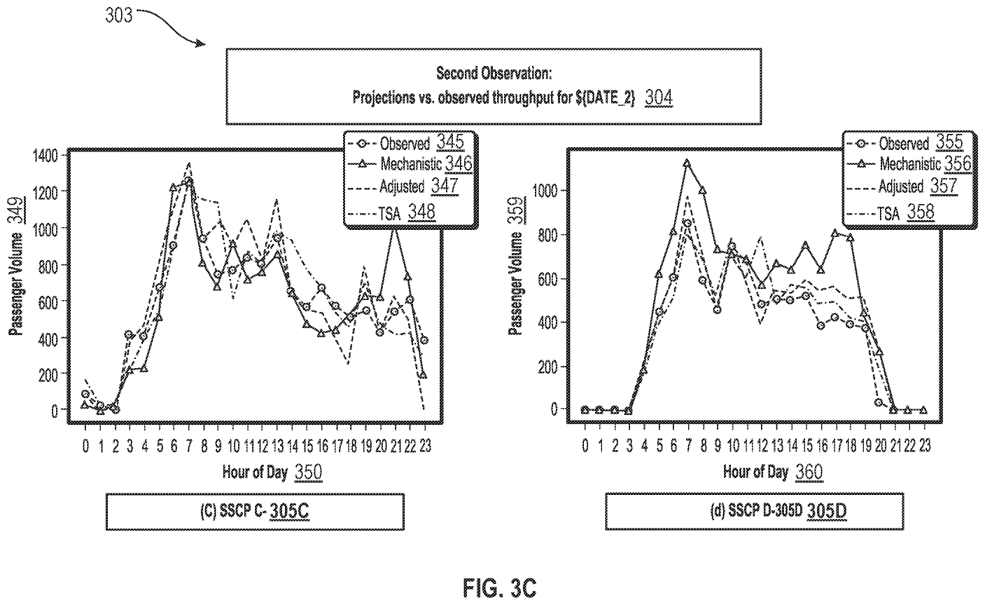

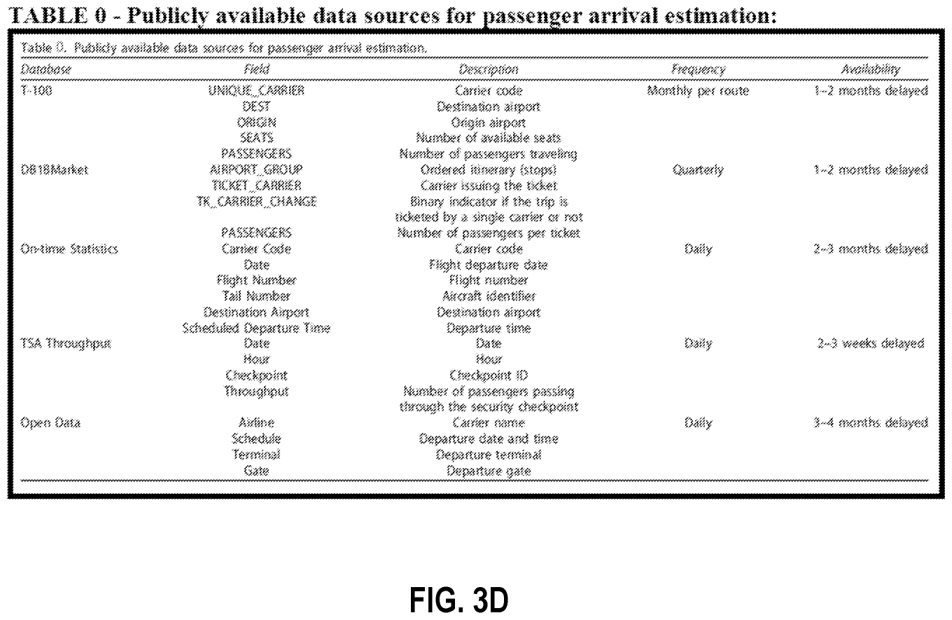

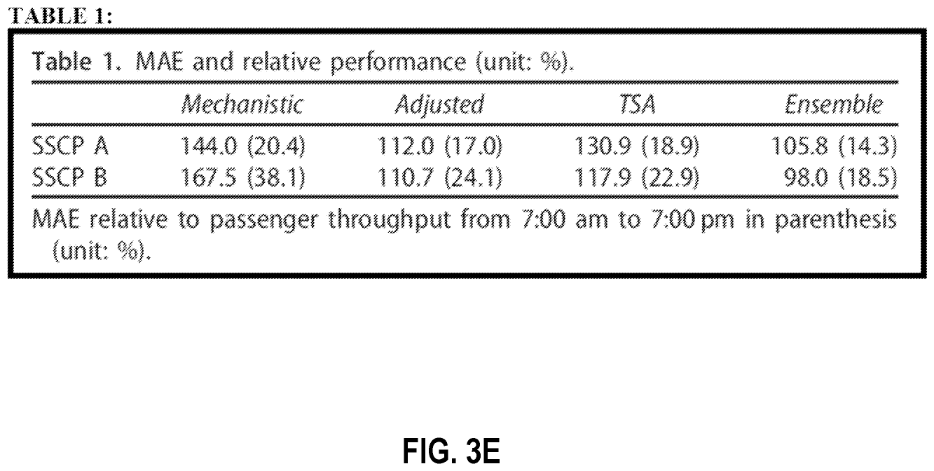

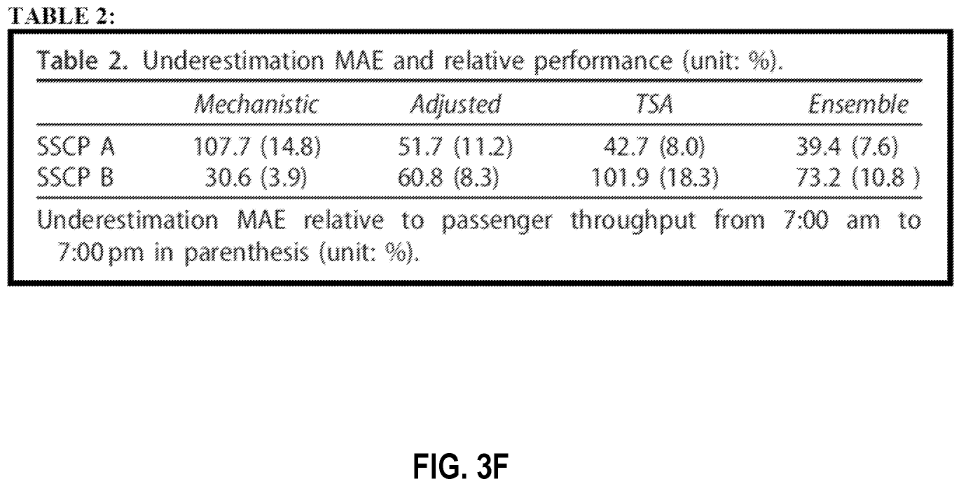

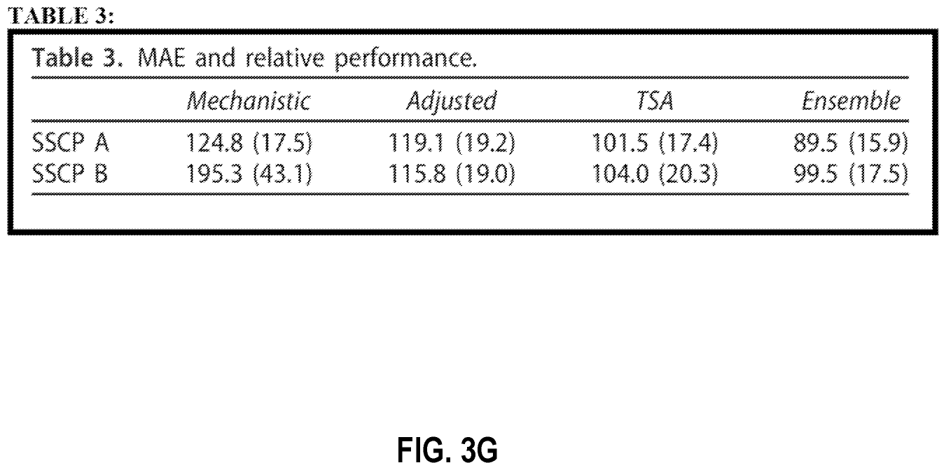

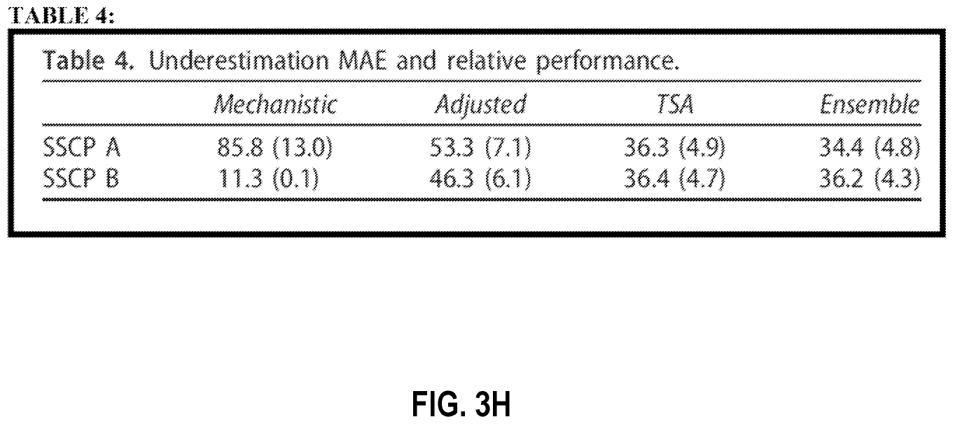

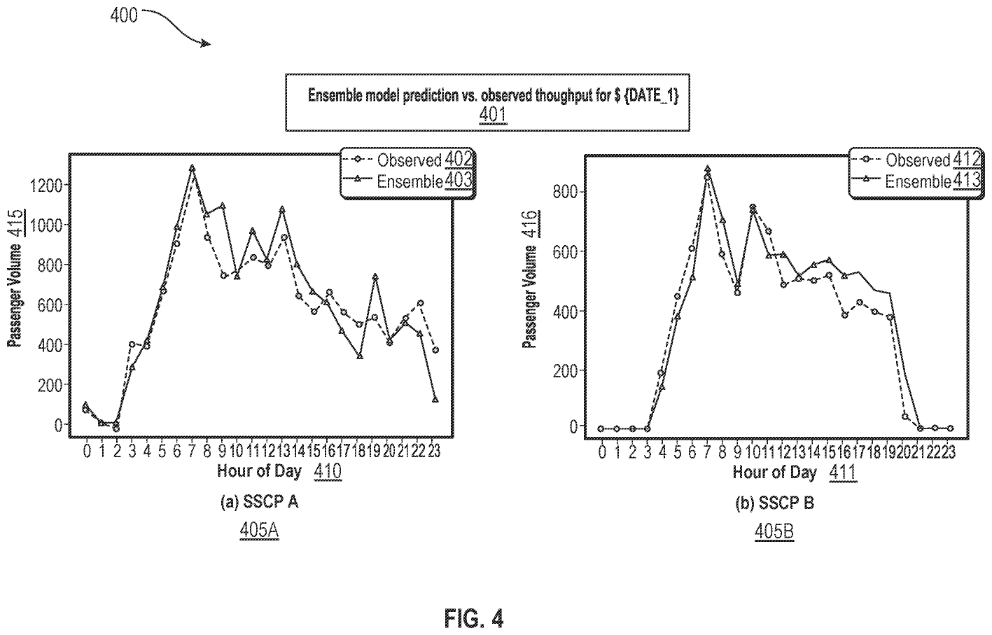

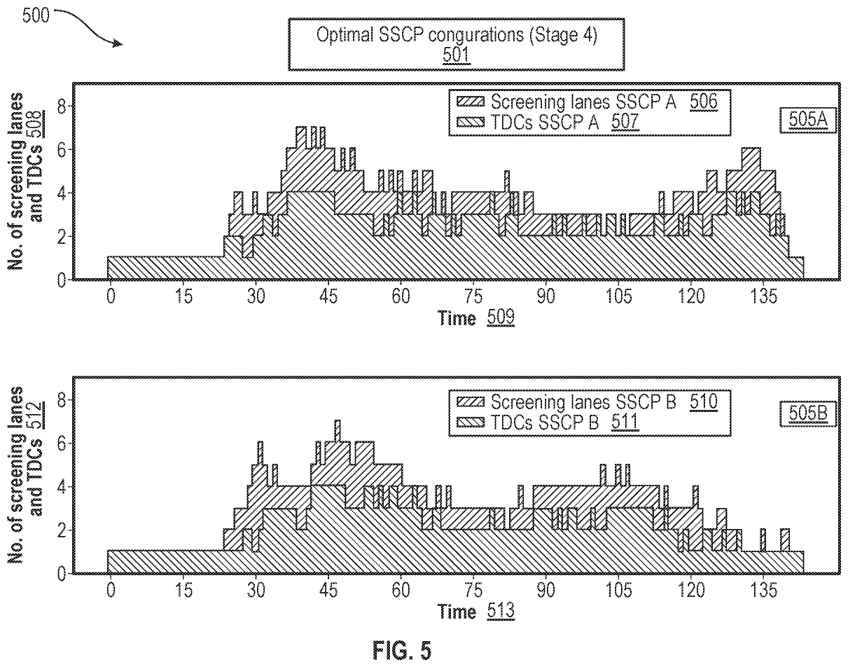

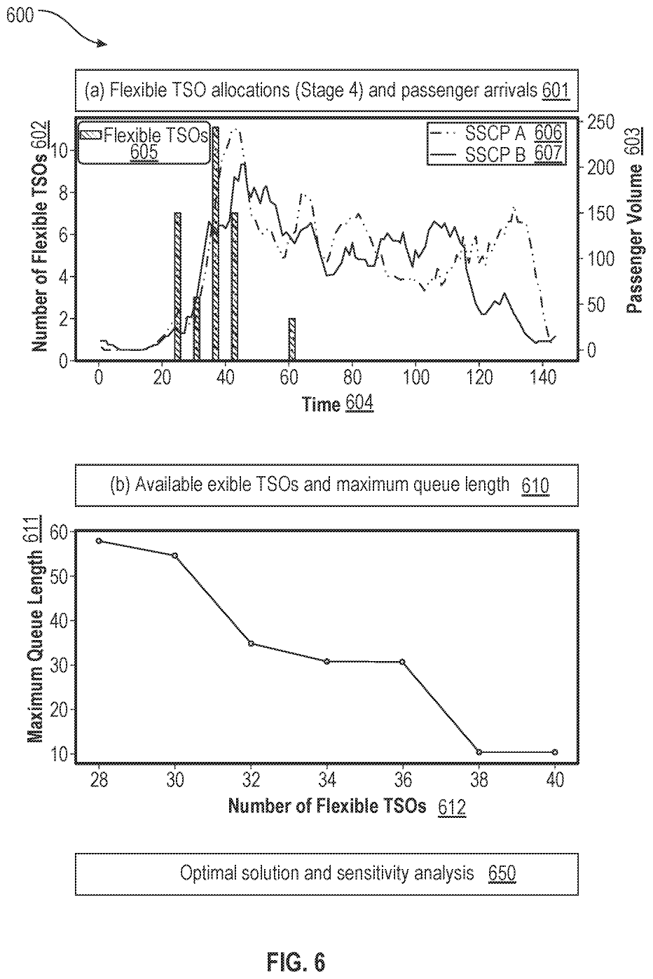

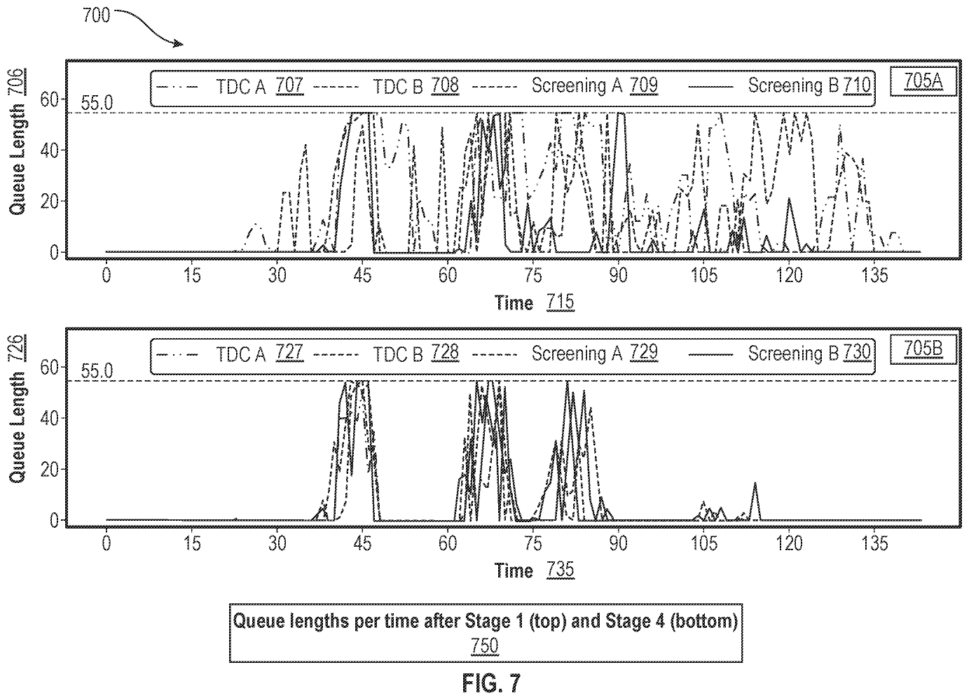

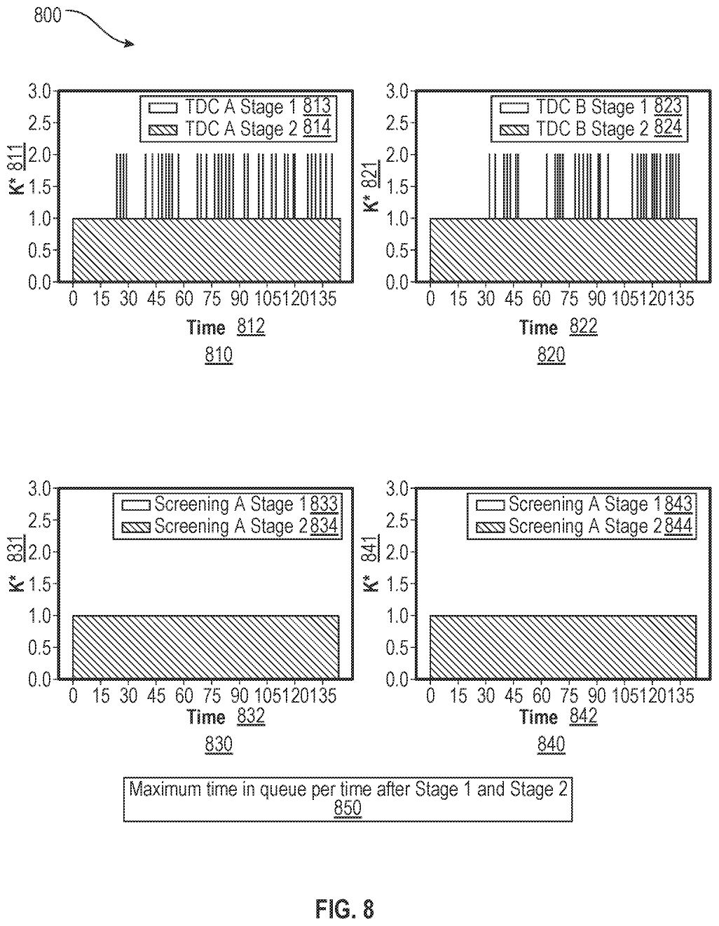

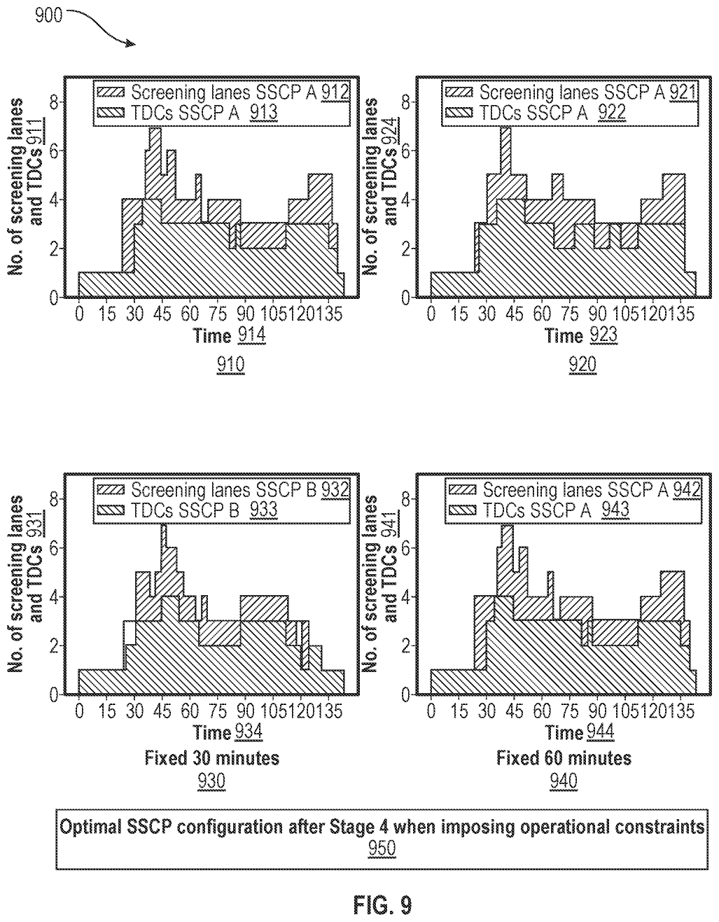

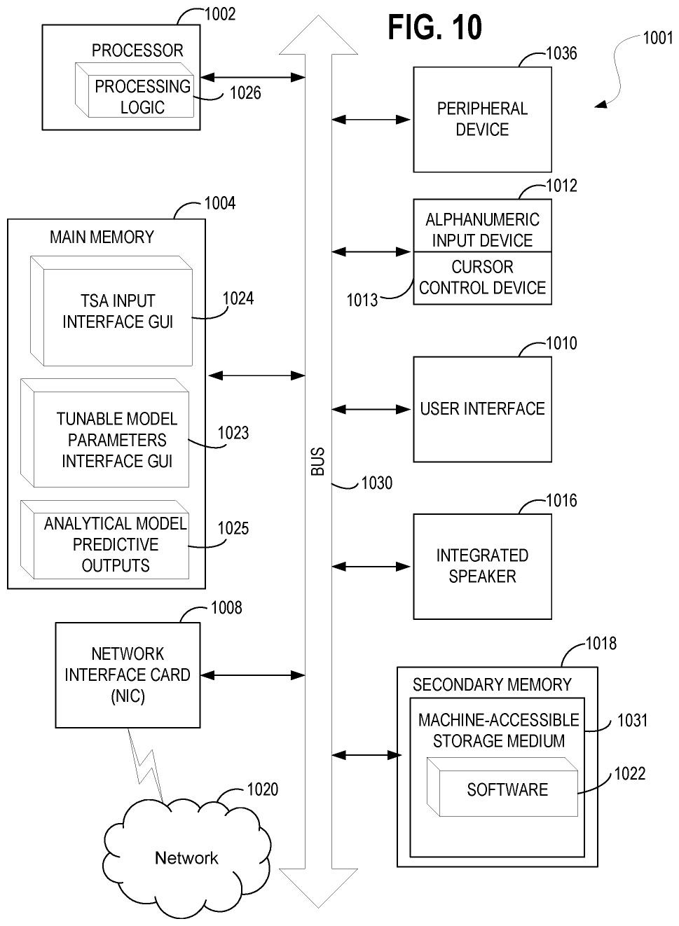

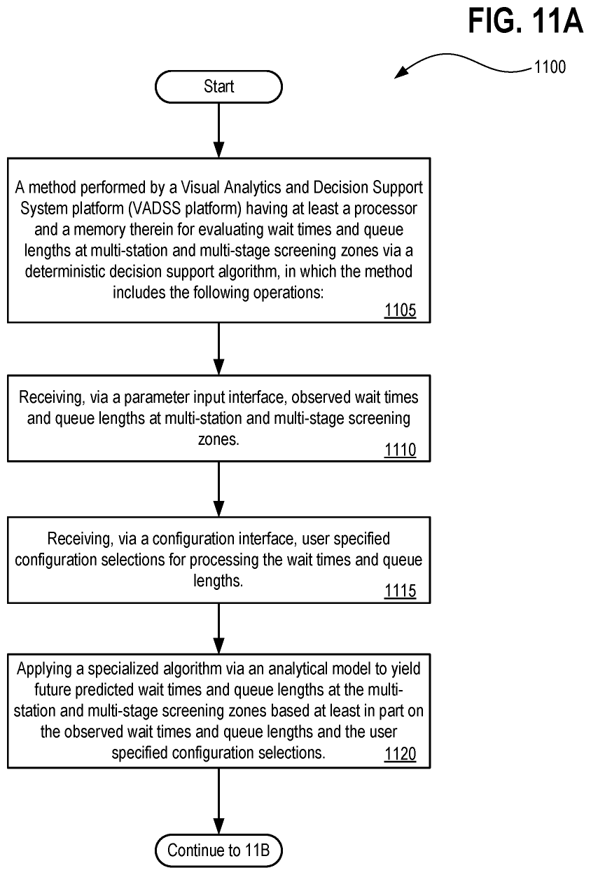

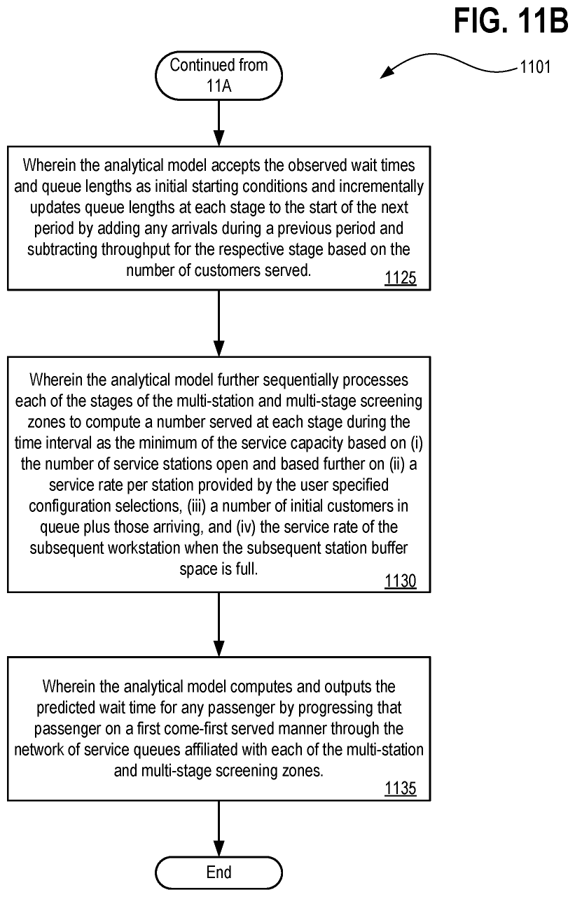

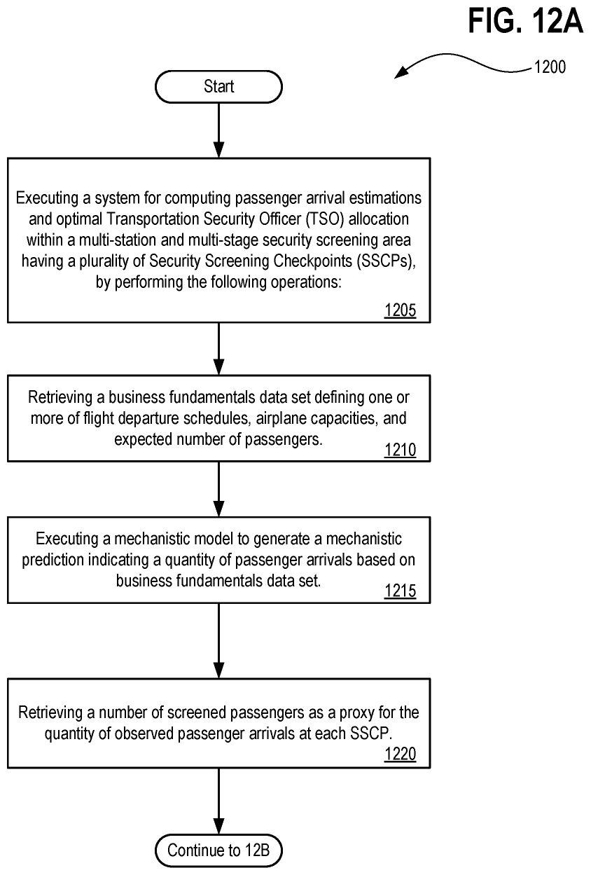

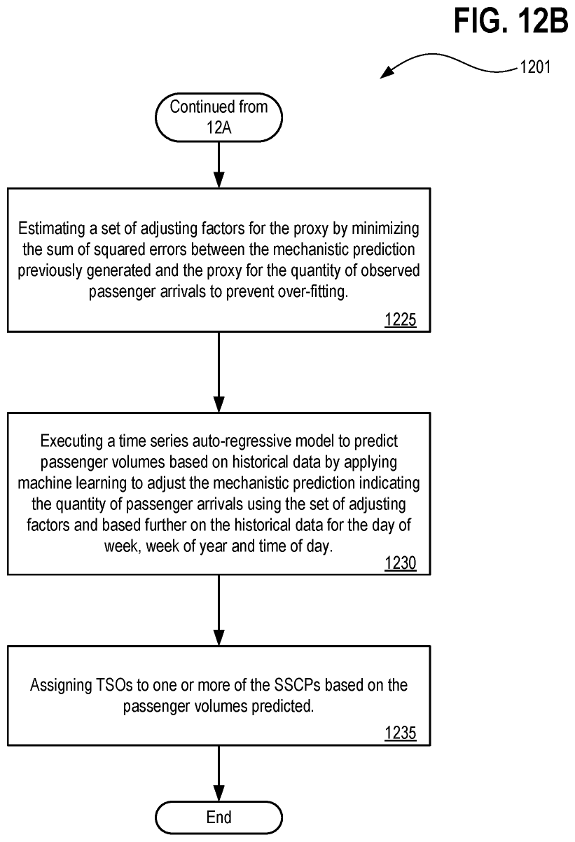

FIGS. 3A, 3B, and 3C depict parameter tuning and observed projections versus reality for the model for improving airport security operations, in accordance with described embodiments.

Further to the description above, the Transportation Security Administration (TSA) was established with the mission to “protect the nation's transportation systems to ensure freedom of movement for people and commerce” As part of that mission, the TSA screens departing passengers and baggage at every airport in the country. In 2018, the TSA screened over two million travelers per day nationwide, more than 813 million passengers and crew members during the entire year.

Such screening operations are of great importance for national security. However, the reality is that thorough screening is time-consuming and may constitute a significant portion of any given passenger's time spent at the airport. Long waits at security queues are a source of discomfort and frustration. Due to increasing passenger volumes, balancing wait times at screening points and security levels is a constant challenge for the TSA. Critical decisions include the number of screening lanes open, and hence, the required number of Transportation Security Officers (TSOs) at any time. New demand prediction and workforce management tools are therefore described herein with the objective of improving the TSA's operational efficiency in response to airport space constraints, growth in air travel, and increasing security threats.

The TSA conducts screening procedures for all departing passengers and carry-on baggage prior to boarding. To execute these procedures, US airports have a number of Security Screening Check Points (SSCPs) that are the only access point to departure gates. Each SSCP has one or more queues leading up to Travel Document Checkers (TDCs), who verify every passenger's boarding pass against their identity. Upon verification, TSOs at the TDC stations direct passengers to a set of primary screening lanes. Typically, each lane has its own conveyor belt feeding a scanner, a walk-through metal detector (WTMD), and an Advanced Imaging Technology (AIT) body scanner. When a person or an item fails to pass the primary inspection, that person or item will be directed to a secondary inspection (open bag or pat-down). Randomly selected passengers may also be asked to pass additional checks such as a chemical residue test.

New technologies and passenger classes are constantly being considered by TSA to enhance security and passenger convenience. The operation of SSCPs is challenging given the multiple sources of uncertainty. Although the number of passengers on a flight is known to some degree of accuracy, the time at which they arrive at the SSCP prior to departure is uncertain. Other factors such as flight delays, gate changes, and number of passengers making a connection also contribute to the demand uncertainty. To keep lanes short in this uncertain environment, the TSA dynamically opens and closes screening lanes and TDCs. However, keeping many lanes open all the time is not economically efficient, whereas having fewer lanes open may lead to long passenger wait times.

Consequently, accurate demand predictions and automated models to determine optimal SSCP configurations have an important impact on TSA operations.

Described embodiments therefore demonstrate that combining prediction models of different nature (i.e., an ensemble of models) results in a more accurate passenger forecast compared with individual models. Additionally, disclosed embodiments provide quantifiable evidence that proactive queue management and timely re-configurations can improve the SSCP performance even under resource limitations. Described embodiments further illustrate that the flexibility of available workforce and ability to re-configure quickly can translate into shorter queues and wait times, which can be used to justify the adoption of new screening technologies.

As set forth below, provided methodologies focus on two critical tasks to improve SSCP operations: Firstly, the passenger forecasting and secondly, the SSCP configuration decisions including workforce allocations.

Passenger Arrival Estimation:

In accordance with disclosed embodiments, three components are specifically combined to estimate the number of passengers arriving at each SSCP (i.e., passenger arrivals).

Specifically, the first component is a mechanistic model to predict passenger arrivals based on business fundamentals such as flight departure schedules, airplane capacities, and expected number of passengers, among other factors. The second component is a learning model that improves the mechanistic prediction by using adjusting factors obtained from a training set of historical information. And the third component is a time series (auto-regressive) model that predicts passenger volumes based on historical data.

To capture both the historical passenger trends and the passenger volumes expected as a function of the industry drivers, an ensemble model is disclosed which averages the adjusted mechanistic and the time series predictions (e.g., second and third components).

As set forth herein, ensemble models combine the results of multiple alternative models and are thus able to both reduce the prediction variance and produce more accurate results than individual models. As described herein, the mechanistic model complements the predictions that are solely based on historical information, thus allowing a TSA analyst to make what-if analyses on the expected passenger volumes due to (possibly never observed) changes in the business drivers. These changes may be due to new or re-scheduled flights, increase in aircraft capacity, passenger behavior changes affecting the arrival time at the SSCP (e.g., shopping and dining at the airport), and terminal or gate closures, among other factors.

Moreover, the mechanistic model enables the downscaling of the prediction of the autoregressive model given that historical SSCP's passenger throughput is typically collected per hour, whereas the forecast is required at a finer scale (e.g., 10-minute intervals).

Mechanistic Passenger Arrival Model:

Described embodiments specifically estimate passenger arrivals in each 10-minute interval for each day during the period of analysis, although other intervals may be utilized. These dynamic arrivals are described using a causal model based on travel industry factors. The most evident driver is the number and type of flights that are scheduled to depart in upcoming time intervals. Different departure schedules capture seasonal variations in airline operations, and consequently yield different passenger arrival patterns, resulting in a mechanistic factor that may be referred to as a “schedule.”

Additionally, the aircraft capacity is the maximum number of departing passengers, which depends on the aircraft equipment type and seat configuration. However, many flights are not full, thus an expected percentage of occupancy, or load factor, is included within the described mechanistic model.

In the US, most airlines use a hub-and-spoke model for their operations. As a result, direct flights are not always available and passengers may have to change flights at a hub airport. Passengers making domestic connections usually stay in the secured side of the terminal and thus avoid passing through a SSCP a second time, which means that only a fraction of all passengers in a flight originate at the departure airport. This factor may be referred to as the percentage of originating passengers. Depending on their preferences, passengers arrive at the SSCP at some time prior to the scheduled departure time. These arrival times may vary considerably and can drastically affect the passenger arrival predictions. Therefore, these behaviors are incorporated into the disclosed models by using an earliness arrival distribution, which provides the proportion of passengers arriving at various times prior to departure.

Finally, departing flights are associated with a SSCP based on the location of their predicted departure gate. To predict passenger arrivals at a specific SSCP, the proposed mechanistic model estimates the expected number of passengers on each scheduled flight and distributes them into time intervals prior to departure according to the earliness arrival distribution. This prediction is then further adjusted by including the originating percentage and the expected distribution of flights into gates, which determines the SSCP used by passengers.

Mathematically, D is defined as the set of days for which predictions are needed (e.g., days during the next two weeks), while T is defined as the set of time periods in which each day is partitioned (e.g., 10-minute intervals), and Fⱼ is defined as the set of scheduled flights on day jϵD, and G is defined as the set of SSCPs. For any day jϵD, the capacity, load factor, and percentage of originating passengers of flight kϵFⱼ is denoted by cₖ, lₖ, and oₖ, respectively. Moreover, the parameter αₖₜ is used to represent the probability a passenger arrives at time period tϵT prior to departure of flight kϵFⱼ. If the departure time of flight k is t̅, then αₖₜ=0, ∀t>t̅.

Flights are distributed across security checkpoints depending on their gate assignment. To do so, parameter r_{g} represents the percentage of flights assigned to security checkpoint gϵG. Using these elements, the estimated number of passengers at security checkpoint gϵG is calculated for time interval tϵT on day jϵD via equation 1, as follows:

$${p}_{gjt} = {r}_{g} {\sum }_{k ∈ {F}_{j}} {c}_{k} {l}_{k} {o}_{k} {α}_{kt} . \qquad Equation 1$$

For any given flight kϵF₁, the term cₖlₖoₖ in Equation (1) calculates the estimated number of passengers after correcting the aircraft capacity by the load factor and the percentage of originating passengers. The parameters required in Equation (1) are estimated using information on scheduled flights, as well as data from the same day and time from previous years.

Learning Approach to Adjust Mechanistic Model:

One challenging issue in the mechanistic approach is the disparity in the time scales for different input data. As a result, the predicted variability achieved by the mechanistic model is limited by the granularity of the input data. For example, available load factors from the Bureau of Transportation Statistics are the same for all days of the week and hour of the day. Intuitively, load factors may change throughout the day and across days. Moreover, unpredictable factors such as gate changes, variability in the earliness arrival curves per type of flight (e.g., business vs. leisure trips), and flight delays, among others, are not captured by the mechanistic approach due to the absence of data. This means that some parameters need to be approximated, for instance, using αₜ instead of αₖₜ.

A simple learning model is therefore provided based on historical passenger volumes to improve the predictive performance of the mechanistic model. This model is able to capture a higher level of detail that is not possible with available input data. By doing so, available information is adjusted from a monthly level—which is the frequency of some of the mechanistic model's input data—to a daily or even hourly level. Moreover, this approach allows for the capture unpredictable factors that are not included the mechanistic model but that play a role in the passenger arrival predictions. This allows accommodation of factors such as airport staff passing through the SSCPs.

The resulting learning approach thus forms a hybrid forecasting model that uses mechanistic model estimates at a prior date and compares them with observed passenger arrivals at each SSCP. As passenger arrivals at the beginning of the SSCP's queue are not generally recorded, the number of screened passengers is used as a proxy (i.e., passengers that passed through an Advanced Imaging Technology (AIT) full body scanner or Walk Through Metal Detector (WTMD). A set of adjusting factors is then estimated by minimizing the sum of squared errors between the mechanistic prediction and the observed throughput under certain rules to prevent over-fitting. These multiplicative factors are used to adjust current mechanistic predictions, which are validated using a reserved sample of observed throughput, as is described in greater detail below.

Formally, let H be the set of hours of the day and let Sⱼ be a sample of prior days to train the adjusting factors for day jϵD. For instance, to calculate the adjusting factors for a given Monday in the future, the corresponding S-set may include the same day in prior years. The construction of these sets is flexible so the analyst can include any subset of days that are relevant for the training. To perform the data training, we require the throughput data as well as the information needed to estimate the parameters of the mechanistic model to be available for each day in Sⱼ for all jϵD. Moreover, it is assumed that throughput data is available per hour, so that the mechanistic predictions are at a finer scale (i.e., |T|≥|H|=24). For each day jϵD, the term \hat{p}_{gsh} is defined as the aggregated mechanistic predictions for hour hϵH of day sϵSⱼ at security checkpoint gϵG.

Thus, if the time scale in the mechanistic model is set to 10-minute intervals, then \hat{p}_{gsh} is the sum of p_{gst} over all six time periods t belonging to hour h. The term T_{gsh} is used to denote the observed throughput at security checkpoint gϵG during hour hϵH of day sϵSⱼ. The adjusting factors for the mechanistic predictions for hour hϵH of day jϵD at SSCP gϵG are given by β_{gjh}.

Adjusting factors for hour hϵH of day jϵD at security checkpoint gϵG are estimated using the constrained least-squares training model [T_{gjh}] as shown at equations 2 and 3, as follows:

$$\begin{matrix}[ {T}_{gjh} ] min {\sum }_{s ∈ {S}_{j}} {( {τ}_{gsh} - {β}_{gjh} {p}_{gsh} )}^{2} & Equation 2 \\ s . t . {l}_{gh} \leq {β}_{gjh} \leq {u}_{gh} & Equation 3\end{matrix}$$

Parameters l_{gh} and u_{gh} control the strength of the correction applied to the mechanistic model to prevent over-fitting during the training phase, which could otherwise deteriorate the quality of the prediction. For instance, an l-parameter equal to 0.75 allows the mechanistic prediction to be reduced by no more than 25%, whereas a u-parameter equal to 1.25 allows the mechanistic prediction to be increased by no more than 25%.

The objective function in equation (2) minimizes the sum of squared errors between the observed throughput and the corrected mechanistic prediction for each of the training days in S Note that there is a single adjusting parameter for each checkpoint-day-hour combination that needs to be estimated to minimize the error across training days subject to the bound constraints in equation (3). Further more, model [T_{gjh}] is a convex univariate optimization problem with linear constraints that can be solved using first-order optimality conditions. Solving [T_{gjh}] for each checkpoint-day-hour combination provides a full set of β-parameters that can be used to adjust mechanistic predictions.

For further illustration, provided below are the steps required by an exemplary learning approach to estimate passenger arrivals for a set of days D in 2019, assuming that the training set for any day jϵD (i.e., Sⱼ) consists of all same days of the week for the same month in 2018. For instance, the training set of a Monday in March 2019 consists of all Mondays in March 2018. This approach may be useful in airports with strong seasonal patterns so that weekly or monthly airline operations are similar across consecutive years (i.e., same number of flights due to seasonal patterns).

Step 1: Using (1), construct previous year y−1 (e.g., y−1=2018) mechanistic estimations for each training day sϵSⱼ, SSCP gϵG, and time interval tϵT. To calculate the year y−1 parameters needed in equation (1), use data from y−2 or y−1 that is available prior to day sϵSⱼ, for each jϵD. Obtain y−1 values of p_{gst}, for each gϵG, sϵSⱼ, and tϵT.

Step 2: Construct aggregated mechanistic predictions \hat{p}_{gsh} by adding p_{gst} over all time periods t belonging to each hour h. Observed throughput for checkpoint g, training day s, and hour h must be available.

Step 3: Using observed throughput and aggregated mechanistic predictions from Step 2, solve [T_{gjh}] for each checkpoint g, day j, and time interval h required for the year y prediction. Obtain adjusting factors β_{gjh}.

Step 4: Using equation (1), construct mechanistic estimations for year y. To keep the estimation consistent, use the same data sources and estimation methods as in Step 1. Obtain year y mechanistic predictions p_{gjt}.

Step 5: Using adjusting factors from Step 3, calculate the corrected mechanistic prediction for year y, checkpoint g, day j, and time interval t, which are given by λ_{gjt}=β_{gjh}p_{gjt}. Note that the factor used to adjust p_{gjt} is that for which time period t belongs to hour h.

The consistency requirement in Step 4 is important because the learning method is designed to correct missing aspects of the mechanistic prediction in equation (1). If the mechanistic estimations are constructed using different methodologies, then the adjusting factors may be misleading, as they were trained to correct something that the current mechanistic predictions may not be lacking. The trade-off between model complexity and generalizability is an important aspect of machine learning models.

Model complexity for the proposed learning model is controlled by varying upper and lower bounds l_{gh} and u_{gh} in equation (3), which are viewed as hyper-parameters. Model selection is performed using cross-validation to determine the best values of land u-parameters. Using cross validation, over-fitting of the training data is avoided and ensures the chosen bounds result in a model which generalizes well.

Training is performed by removing one training day at a time, fitting the adjusting factors, and then predicting the throughput for the removed day. The values with minimal cumulative prediction error are selected. Due to the small sample size of the training data, the applicability of more sophisticated cross validation procedures (such as k-fold cross validation or holdout sampling) is limited. Based on initial empirical limits and an understanding of the factors excluded from the mechanistic model, a grid search was conducted for bounds from zero to two with a step size of 0.1. Once the empirical bounds are obtained, the optimization problem T_{gjh} is solved using all training days in Sⱼ to obtain the final adjusting factors.

As opposed to the multiplicative adjusted mechanistic model described above, an autoregressive prediction is described by a weighted linear sum of prior information. This could take the form \hat{τ}_{gjh}=δ_{g}+Σ_{(j′,h′)ϵτih}ϕ_{j′h′}τ_{gj′h′}, where \hat{τ}_{gjh} is the prediction of the number of passengers arriving at checkpoint g at time interval t within hour h, Tⱼₕ is the set of pairs of indices (j′, h′) corresponding to day j′ and hour h′ that is used to predict the number of passengers expected in day jϵD at hour hϵH, with j′≤j, h′≤h, and (j′,h′)≠(j,h), and δ_{g} and ϕ_{j′h′} are constants.

The current prediction model used by the TSA (Sky Harbor airport, Phoenix) follows this auto-regressive principle, combining historical passenger volumes from prior days and hours to produce the \hat{τ}-values. These passenger arrival predictions are per hour, thus they are downscaled to finer time intervals t (e.g., 10-minute intervals) by calculating λ′_{gjt}=α_{ght}\hat{τ}_{gjh}, where α_{ght} is the percentage of passengers arriving at checkpoint g at time interval t within hour h. The α-coefficients can be calculated using the proportion of arrivals at time interval t within hour h based on the mechanistic model. To obtain the ensemble predictions, the predictions from the adjusted mechanistic model and those from the autoregressive-type model currently used for prediction are averaged together. That is to say, the expected number of passengers arriving at checkpoint g, on day j, and at time interval t is given by λ_{gjt}=½(\tilde{λ}_{gjt}+λ′_{gjt}).

Optimal Checkpoint Configuration and Workforce Allocation:

Accurate passenger arrival predictions are important, as they can inform staffing decisions seeking a high quality of service at each SSCP. Therefore, a mixed-integer optimization model is presented with a solution algorithm to determine an optimal number of TDC stations and identical parallel screening lanes operating at any given time in order to optimize the checkpoint performance (e.g., minimize queue lengths and minimize wait times).

Indirectly, the resulting model also determines the corresponding allocation of TSOs to the SSCP at any given time. The model is described in greater detail below, in which the disclosed optimization model, incorporates operational requirements such as available labor, business rules to open and close a TDC or a screening lane, and queue dynamics for each candidate configuration. Further described is a solution approach to explore the alternative optimal solutions provided by the disclosed optimization model. The proposed approach incorporates multiple desired outcomes such as minimum worst-case queue length across the day, minimum additional TSOs needed to achieve a service level, and minimum queue length at any time.

Mathematical Programming of the Optimization Model:

The described optimization model evaluates the performance of each checkpoint using the expected queue length for each time interval of the day, which is driven by the passenger arrivals and the chosen shift configuration.

From a managerial point of view, it is justifiable to minimize the maximum queue length across the day, as the quality of service perceived by a passenger is directly related to their own wait time rather than an overall daily performance. To calculate queue lengths, the model embeds the governing equations of a multi-server queuing network model, whose parameters are a function of the configuration decisions.

A Security Screening CheckPoint (SSCP) is therefore modeled as a sequence of two stages, TDC and baggage/passenger screening, at which passengers can spend time in a queue. As baggage screening is typically slower than passenger screening (i.e., passage through an AIT or WTMD), baggage processing rates per passenger are utilized as screening rates. A configuration is defined by the number of TDCs and screening lanes open at a point in time.

Mathematically, the term C is defined as the set of TDC areas in the airport and A is defined as the set of screening areas. Each checkpoint consists of one TDC area and one screening area. A TDC area has the capacity for multiple TDC stations and a screening area has multiple screening lanes. TDC and screening areas have a set of possible configurations given by Kᵢ, for iϵC [symbol] A. The finite set of candidate configurations is determined by each checkpoint's layout and available equipment (e.g., TDC stations, AIT machines). Parameter [symbol] captures the number of screening lanes available in area iϵA under configuration [symbol] . To prevent drastic changes in a checkpoint configuration over time, K̅ᵢ( [symbol] ) is defined as the set of incompatible configurations with configuration [symbol] at area iϵC [symbol] A. If configuration [symbol] is selected at time t for area i, then none of the configurations in K̅ᵢ( [symbol] can be selected at t+1 for the same area. These rules prevent reconfigurations of checkpoints that are undesirable in practice. Decision variable [symbol] equals one if configuration [symbol] is used at area i during time period t, and is equal to zero otherwise.

To model the queuing process, Qᵢₜ is defined as the queue length at the end of time t, assuming that Qᵢ₀=0, and μᵢₜ as the effective service rate at area i during time t, respectively. The effective service rate is defined by the configuration (number of active lanes) and the TSA standard throughput rate per lane. Note that these factors can be adjusted based on specific SSCP characteristics such as space limitations or specific policies of the airlines served by that SSCP. A parameter λᵢₜ is used to denote the estimated passenger arrivals to TDC area i—i.e., to the SSCP where area i is located—during time period t. This parameter is estimated using the results in Section 3 and corresponds to λ_{git} when area iϵC is the TDC of checkpoint g and j is the day of analysis. The number of processed passengers at any area is bounded by the number of passengers available and the processing capacity. Due to the sequential configuration of an SSCP, each TDC area has a unique screening area to which passengers move after ID verification. To formally model this relationship, j(i)ϵC is defined as the TDC area immediately before screening area iϵA and cᵢₜ is defined as the number of passengers processed in area i at time t. These conditions are set forth at equation 4 and are thus written, as follows:

$${c}_{it} = \{ \begin{matrix}min \{ {Q}_{i , t - 1} + {λ}_{it} , {μ}_{it} \} & i ∈ C \\ min \{ {Q}_{i , t - 1} + {c}_{j ( u ) , t} , {μ}_{it} \} & i ∈ A\end{matrix} \qquad Equation 4$$

where C_{j(i),t} is the number of passengers processed at the TDC area preceding screening area i at time t. In other words, C_{j(i),t} for iϵA is the number of passengers entering screening area i after clearing the TDC procedures in area j(i)ϵC. The processing rate of area i under configuration [symbol] is given by [symbol] and the maximum queue length observed across all times tϵT is given by \hat{Q}. The number of passengers waiting in any screening lane at any time should be no more than P, which captures the limited space available inside the SSCP.

That is to say, it is assumed that queues in the screening area have finite buffers. When they reach their capacity, the TDC queue absorbs the excess of passengers, which is a phenomenon observed in the physical system when TSOs working at the TDCs temporarily stop verifying IDs until the screening area has available capacity. To capture existing labor constraints, Lₜ is defined as the number of TSOs assigned to the SSCP under analysis at time t (i.e., on duty). Moreover, [symbol] denotes the number of TSOs required to operate area i under configuration [symbol] . The model further assumes that a number of flexible TSOs are available to work at the SSCP if needed. However, their working shifts need to be determined depending on the needs of the SSCP. Thus, the model includes these decisions using a set of predetermined shifts. Each shift is a collection of times in which a TSO is working at the SSCP. The set of shifts, denoted by Ω, reflects agency-specific constraints such as shift duration (i.e., part-time and full-time), breaks, among other features. The decision variable h_{f} is used to determine the number of flexible TSOs working under shift fϵΩ. The number of available flexible TSOs is no more than B (i.e., beyond those included in Lₜ).

Thus, depicted below at equations 5 through 20, is an exemplary optimization model capable of determining optimal SSCP configurations and workforce allocation decisions, as follows:

$$\begin{matrix}min \hat{Q} & Equation 5 \\ s . t . {\sum }_{ℓ ∈ {i}_{}} {x}_{i ℓ t} = 1 , i ∈ C ⋃ A , t ∈ T & Equation 6 \\ {\sum }_{ℓ ∈ {i}_{}} {r}_{i ℓ} {x}_{i ℓ t} = {μ}_{it} , i ∈ C ⋃ A , t ∈ T & Equation 7 \\ {\sum }_{i ∈ C ⋃ A} {\sum }_{ℓ ∈ {i}_{}} {l}_{i ℓ} {x}_{i ℓ t} \leq {L}_{i} + {\sum }_{\{ f ∈ Ω \text{:} t ∈ f \}} {h}_{f} , t ∈ T & Equation 8 \\ {\sum }_{f ∈ Ω} {h}_{f} \leq B & Equation 9 \\ {Q}_{it} \leq \hat{Q} , i ∈ C ⋃ A , t ∈ T & Equation 10 \\ {Q}_{i , t - 1} + {ζ}_{it} \geq {c}_{it} , i ∈ C , t ∈ T & Equation 11 \\ {Q}_{i , t - 1} + {c}_{j ( i ) , t} \geq {c}_{it} , i ∈ A , t ∈ T & Equation 12 \\ {μ}_{it} \geq {c}_{it} , i ∈ C ⋃ A , t ∈ T & Equation 13 \\ {Q}_{i , t - 1} + {λ}_{it} - {c}_{it} = {Q}_{it} , i ∈ C , t ∈ T & Equation 14 \\ {Q}_{i , t - 1} + {c}_{j ( i ) , t} - {c}_{it} = {Q}_{it} , i ∈ A , t ∈ T & Equation 15 \\ {Q}_{it} \leq P {\sum }_{ℓ ∈ {i}_{}} {n}_{i ℓ} {x}_{i ℓ t} , i ∈ A , t ∈ T & Equation 16 \\ {x}_{i ℓ t} \leq 1 - {x}_{i , \overline{ℓ} , t + 1} , i ∈ A , ℓ ∈ {i}_{} , \overline{ℓ} ∈ {{\_}^{}}_{i} ( ℓ ) , t ∈ T & Equation 17 \\ {x}_{i ℓ t} ∈ \{ 0 , 1 \} , i ∈ C ⋃ A , ℓ ∈ {i}_{} , t ∈ T & Equation 18 \\ {μ}_{it} , {Q}_{it} , {c}_{it} \geq 0 , i ∈ C ⋃ A , t ∈ T & Equation 19 \\ {h}_{f} ∈ ℕ , f ∈ Ω . & Equation 20\end{matrix}$$

Constraints at equation (6) guarantee that exactly one configuration is selected for each area and time period. Constraints at equation (7) calculate the effective processing rate at each area as a function of the chosen configuration. The labor availability is imposed by Constraints at equation (8) for each time period, where the left-hand side is the number of officers needed airport-wide given the chosen configurations and the right-hand side is the number of TSOs available including those under a flexible schedule. The number of TSOs working under shift f is only accounted in the labor constraint of time t if the shift covers such period (i.e., if tϵf for any shift fϵΩ). The Constraint at equation (9) imposes a limit on the maximum number of flexible TSOs available, which in this case is modeled as a cardinality constraint because it is assumed that any officer earns the same wage. The flexible TSO feature could also serve to model use of overtime. Constraints at equation (10) enforce that \hat{Q} is greater than or equal to the maximum queue length observed in any area at any time, which together with the objective function in equation (5) helps minimize the maximum queue length. Constraints at equations (11), (12) and (13) linerarize Equation (4) for each area and time. Given the model's objective to limit queue lengths, one constraint between (11) and (12) or (13) will be binding depending on the area. The checkpoint's queue dynamics are governed by Constraints at equations (14) and (15). The difference between the number of passengers (in queue and arriving) and the number of passengers processed at an area at a given time determines the passengers in queue for the next time period. Constraints at equation (16) capture the finite-buffer nature of the screening lanes. Constraints at equations (18)-(20) define the nature of the model's decision variables. The operational rules related to changes in the SSCP configuration are incorporated by using Constraints at equation (17), which guarantee that consecutive configuration changes (i.e., configurations at times t and t+1) in an area follow the compatibility rules, meaning that no drastic changes are allowed. In this case, if [symbol] =1, then all the variables related to the selection of incompatible configurations for the same area at time t+1 must be equal to zero. For example, if the configuration for screening area i at time period t consist of three screening lanes, then the allowed configurations for t+1 may be two, three, or four lanes only, and no other configuration can be selected. Constraints at equation (17) narrow down the possibilities for a configuration change between consecutive time periods. However, they allow repeated changes every time period within the set of compatible options. This situation may be undesirable if setup costs exist, dictating that once a configuration is selected, then it needs to be operated for some time. To address this issue, parameter M is introduced to describe the minimum number of time periods that a configuration needs to be maintained after being selected. Moreover, binary decision variables [symbol] and [symbol] are introduced to record whether configuration [symbol] of area i is changed at time t. In particular, [symbol] determines whether configuration [symbol] is adopted, whereas [symbol] indicates that configuration [symbol] is no longer in use. Under this new approach, the Constraints at equation (17) are removed and in their place, the following new constraints as set forth by equations 21 to 24 are added, as follows:

$$\begin{matrix}{x}_{i ℓ t} - {x}_{i , ℓ , t + 1} + {δ}_{i , ℓ , t + 1}^{a} - {δ}_{i , ℓ , t + 1}^{n} = 0 , i ∈ C ⋃ A , ℓ ∈ , t = 1 , … , \vert T \vert - 1 & Equation 21 \\ {\sum }_{ℓ ∈} {δ}_{i ℓ t}^{u} \leq 1 - {\sum }_{ℓ ∈} {δ}_{i , ℓ , t + m}^{v} , i ∈ C ⋃ A , t = 1 , … , \vert T \vert - M , m = 1 , … , M , u , v ∈ \{ a , n \} & Equation 22 \\ {δ}_{i ℓ t}^{u} = 0 , i ∈ C ⋃ A , ℓ ∈ , t = \vert T \vert - M + 1 , … , \vert T \vert , u ∈ \{ a , n \} & Equation 23 \\ {δ}_{i ℓ t}^{u} ∈ \{ 0 , 1 \} , i ∈ C ⋃ A , ℓ ∈ , t = 1 , … , \vert T \vert - M , u ∈ \{ a , n \} . & Equation 24\end{matrix}$$

Constraints at equation (21) track whether configuration [symbol] in area i is changed between times t and t+1. If this is the case, [symbol] = [symbol] is equal to one or negative one, which requires δ_{i,} [symbol] _{,t+1}^{a} or δ_{i,} [symbol] _{,t+1}ⁿ to be equal to one. As a result, a δ-variable equal to one indicates a change in configuration. Constraints (22) indicate that if there is a change in the configuration of area i at time t (Σ [symbol] _{ϵ} [symbol] δᵢ [symbol] ₜ^{a}=1 or Σ [symbol] _{ϵ} [symbol] δᵢ [symbol] ₜⁿ=1), then no change can happen in the next M periods of time (i.e., Σ [symbol] _{ϵ} [symbol] δ_{i,} [symbol] _{,t+m}^{a}=0 and Σ [symbol] _{ϵ} [symbol] δ_{i,} [symbol] _{,t+m}ⁿ=0, for m=1, . . . , M). Constraints at equation (23) prevent any SSCP re-configuration within the last M periods of the time horizon and Constraints (24) establish the binary nature of δ-variables.

The optimization model described in equations (5)-(20), or the alternative model that consists of equations (5)-(24) except for equation (17), focuses on minimizing the worst-case queue length across periods in T. This objective is relevant when analysts are concerned about overcrowding and its effect on the SSCP's quality of service. An alternative performance metric of interest is the time that a passenger spends at the SSCP. Due to the non-stationary arrivals and the variable processing rates induced by the discrete changes in the SSCP configuration, the time with the worst-case queue length is not necessarily that with the longest wait time. To incorporate both performance metrics, the existing model is modified and the decision variables \tilde{Q}_{itt′} are defined, which indicate the number of passengers in the queue at the end of period t in area i that are cleared in period t′, where t′ϵ{t+1, . . . , min{|T|, t+Kᵢ}} and Kᵢ>0 is the maximum number of periods that any passenger should wait in the queue in area i. Constraints at equation (25) guarantee that queues in area i are cleared in no more than Kᵢ periods within the planning horizon, with Constraints at equation (26) guaranteeing that the number of passengers cleared from area i at time t′ (i.e., in queue at time t′−1 or up to K periods before) is no more than the available processing capacity. Constraints at equation (27) preserve the nested nature of the \tilde{Q}-variables, where the number of passengers cleared at time t′ that were waiting in the queue at time t₂ include the number of passengers that were in the queue at prior times and that are processed at time t′ too. This is because any passenger waiting in the queue at time t that is not processed becomes part of the queue at time t+1. Constraints at equation (28) guarantee that the number of processed passengers is non-negative, with equations 25 through 28 presented below, as follows:

$$\begin{matrix} {Q}_{i , t - 1} = {\sum }_{{t}^{′} = t}^{min \{ \vert T \vert , t + K \}} {\tilde{Q}}_{i , t - 1 , {t}^{′}} , i ∈ C ⋃ A , t ∈ T & Equation 25 \\ {\tilde{Q}}_{{itt}^{′}} \leq {c}_{{it}^{′}} , i ∈ C ⋃ A , {t}^{′} ∈ T , t = max \{ {t}^{′} - K , 1 \} , … , {t}^{′} - 1 & Equation 26 \\ {\tilde{Q}}_{{it}_{1} {t}^{′}} \leq {\tilde{Q}}_{{it}_{2} {t}^{′}} , {t}_{1} , {t}_{2} , {t}^{′} ∈ T \text{:} {t}_{1} < {t}_{2} < {t}^{′} , {t}^{′} - {t}_{k} \leq K , k = 1 , 2 & Equation 27 \\ {\tilde{Q}}_{{itt}^{′}} \geq 0 , i ∈ C ⋃ A , t ∈ T , {t}^{′} = t , … , min \{ \vert T \vert , t + K \} . & Equation 28\end{matrix}$$

The objective function in equation (29) penalizes any delay in processing passengers after the time they are in the queue, discouraging long wait times. Due to the fast increase in the penalization factor (t′−t+1)², the objective function in equation (29) also induces a queue priority, where passengers are cleared in a first-in-first-out fashion. The model that focuses on minimizing wait times consists of minimizing the objective function in equation (29), subject to Constraints at equations (6)-(20) and (25)-(28), or alternatively, subject to Constraints at equations (6)-(16) and (18)-(28), with equation 29 presented as follows:

$$min {z}_{t} = {\sum }_{i ∈ C ⋃ A} {\sum }_{t ∈ T} {\sum }_{{t}^{′} = t}^{min \{ \vert T \vert , t + K \}} {( {t}^{′} - t + 1 )}^{2} {\tilde{Q}}_{i , t - 1 , {t}^{′}} \qquad Equation 29$$

Solution Approach:

The exemplary optimization model as detailed by equations (5)-(20)—or the alternative model as detailed by equations (5)-(24) excluding equation (17)—minimizes the worst-case queue length across periods in T. The optimal objective function value, which we denote by \hat{Q}*, provides an achievable performance metric given the workforce constraints and available checkpoint configurations. However, there is no incentive in the model to use the minimum number of flexible and on-duty TSOs to achieve the optimal queue performance. Moreover, there is no incentive in the model to maintain short queues at times other than those producing the worst-case performance (i.e., at those times when the Constraint at equation (10) is not binding), because this will not improve the maximum queue length. To overcome these issues, a four-stage-constraint approach is described that iteratively solves for the constraints at equations (5)-(20) (or the alternative model), adding constraints at a time to prevent the deterioration in the objective at previous stages, described below as follows:

Step 1: Solve for the model as described in equations (5)-(20)—or the alternative model as described in equations (5)-(24) except for equation (17)—and obtain the optimal objective function value \hat{Q}*.

Step 2: Solve the problem with objective function of equation (29) subject to the same constraints as the model in Stage 1 and with additional constraints at equations (25)-(28), but replacing the Constraints at equation (10) with Qᵢₜ≤\hat{Q}*, tϵC∪A, tϵT. Obtain the optimal objective function value z*ᵣ and optimal solution \tilde{Q}*_{i,t-1,t′}, iϵC∪A, tϵT, t′=t, . . . , min {|T|, t+K}. For each iϵC∪A and tϵT calculate K*ᵢₜ as the largest integer k such that \tilde{Q}*_{i,t,t+k}>0. That is, K*ᵢₜ is the maximum number of periods (i.e., wait time) required to clear a passenger in queue at the end of period t in area i.

Step 3: Solve the problem zₕ=min Σ_{fϵΩ}h_{f} subject to the same constraints as the model in Stage 2 but replacing the Constraints of equation (25) by Q_{i,t-1}=Σ_{t′=t}^{min{|T|,t+K*}^{ᵢₜ}^{}}\tilde{Q}_{i,t-1,t′}, iϵC [symbol] A, tϵT. Obtain the optimal objective function value z*ₕ.

Step 4: Solve the problem min [symbol] Σ_{tϵT}Qᵢₜ subject to the same constraints as the model in Stage 3 and the additional constraint Σ_{fϵΩ}h_{f}≤z*ₕ.

In Stage 2, queue lengths are bounded by the optimal value of Stage 1, which prevents their deterioration. That is, no solution in Stage 2, 3, or 4 will have a maximum queue length worse than \hat{Q}*. The objective function in Stage 2 is to minimize a function that penalizes any delay in processing passengers, maintaining the same performance from Stage 1. As an output of Stage 2, the model obtains the maximum number of periods required to clear a passenger (i.e., maximum wait time) in the queue at the end of period t in area i, K*ᵢₜ, which is not allowed to deteriorate in future stages. The objective in Stage 3 is to minimize the number of flexible TSOs used, maintaining the same queue performance from Stages 1 and 2. The goal of this stage is to release (if possible) some TSOs from duties at the SSCPs in order to perform other activities, such as training and screening operations at baggage processing. The problem solved in Stage 4 seeks to minimize the summation of queue lengths across all areas and time periods while enforcing that the number of flexible TSOs is no more than the optimal level from Stage 3 and preserving the quality of service from Stages 1 and 2. This stage also aims to bring queue lengths to their minimum throughout the entire day, even at times where queues are not at their worst-case length. That is, Stage 4 discourages the model from keeping unnecessary queues and will utilize processing capacity whenever passengers are present in the TDC or screening queues.

Lastly, note that the described procedure prioritizes the maximum queue length. The model can easily be adjusted to allow a modest increase in maximum queue length to reduce the use of flexible or on-duty TSOs or average queue length by allowing \hat{Q} to increase by some level ϵ in Stage 2, 3 or 4. For instance, the model in Stage 2 may be infeasible if it is not possible to clear the queues in K or less periods. This means that it is impossible to have both short queues (of length \hat{Q}* or less) and short wait times (of K or less periods in each area), which will require either an increase in the maximum allowed queue length or an increase in K in Stage 2.

Data Sources:

Possible data sources are described which may be utilized to estimate the parameters required by the described models. Whenever possible, the benefits and challenges of each source are further described. Due to the competitive nature of the commercial aviation industry, airlines are reluctant to publish historical data related to load factors. The US Department of Homeland Security (DHS), however, requires certain information to be publicly disclosed by airlines. This information is mostly in aggregated form in order to protect an airline's operational information from public disclosure. Additionally, for protection of customer and citizen privacy, personal information to accurately estimate earliness arrival times is never recorded.

One of the major sources of information in this field is the US Department of Transportation's Bureau of Transportation Statistics (BTS). Several databases used in this study are publicly available through BTS and contain reasonably up-to-date information. Other sources of information include DHS reports, third-party agencies (e.g., Official Aviation Guide—OAG), and airport-specific agencies. The characteristics of each potential data source are summarized below.

BTS T-100 Segment. This database reports monthly route information for individual airlines aggregated over a month. This data can be used to estimate the load factor for a given airline, route, and month by using the data on airline, capacity (seats), passengers, origin, and destination.

BTS DB1B Market. This database is also referred to as the Airline Origin and Destination Survey. For instance, a 10% sample of the reported tickets belonging to customers along with the itinerary details of their travel is available quarterly. This data can be used to derive quarterly percentages of people who originated from a particular airport to a specific destination and on an airline by comparing the counts of the entries where that particular airport is a connection itinerary versus a travel start point.

BTS On-time Statistics. This database reports historical flight schedules. A disadvantage of the database is that international flights are not reported. Reported schedules also have the tail number of the aircraft on which a particular flight was operated. Tail numbers can potentially be used to obtain the number of available seats for each reported aircraft.

TSA Reports. Earliness arrival distributions are available in some reports from the Transportation Security Administration. These reports focus on national averages across all US airports and provide earliness arrival distributions for early morning, peak hour, non-peak, and international departures. However, these distributions are general and ignore specific aspects of the type of passengers (business persons vs. tourists), destinations, and time of the day, among other airport-specific aspects.

TSA Throughput Data. TSA reports hourly throughput counts at security checkpoints throughout the country. As these counts are obtained in the screening area (once a passenger goes through the AIT or WTMD), this data is lagged compared with the passenger arrivals given the queuing process. The assumption is that, since the wait times typically are significantly less than an hour, the lag between arrivals and throughput can be neglected and throughput data is a good estimate of the actual arrivals.

OAG. The OAG is a private company specializing on providing aviation data. This database reports flight schedules that can be used to obtain Fⱼ values for equation (1). OAG also reports load factors and percentage of originating passengers. However, the percentage of originating passengers was the same for all flights in most of the sample days analyzed. Moreover, load factors seem to be estimated based on historical information rather than actual ticket purchases.

Additional Open Data. Additional data sources are available for local customization of the model. For instance, a case study for Phoenix Sky Harbor airport is described below. In this case, the city of Phoenix publishes the Worldwide Time Table for all flights departing Sky Harbor. However, the data is only updated monthly and effectively only has accurate flight schedules for the beginning of the month. Also available is the published Aviation Flight Information database with gate assignments for departures, allowing estimation of passenger loads at specific SSCPs.

TSA Secure Flight. This database is based on the Secure Flight airline passenger pre-screening program implemented in the US since 2009. Airlines report to TSA the information of every passenger for every flight several days prior to departure. This is used to compare passenger identities with watch lists maintained by the federal government. This database provides more accurate short-term load factors. However, this information is not available (or is highly inaccurate) for longer term predictions than a week ahead. Access to this information is restricted and needs to be anonymized.

FIG. 3D depicts Table 0, which provides a more detailed description of the publicly available data sources, according to described embodiments.

Results and Discussion:

A case study at Terminal 4 (SSCPs A and B) in Phoenix (Arizona) Sky Harbor airport is described below, in which the results of the passenger arrival estimations as well as two validation procedures are provided. Further still, backtesting using flight departures as they occurred is provided along with a test using projected flight departures. The first validation assesses the model accuracy under complete information, whereas the second validation replicates a real prediction exercise using the available information at the decision-making time. In both cases, results are compared with observed passenger throughput and the workforce allocation models are then illustrated as utilized experimentally with such data.

Validation of Passenger Arrival Estimations—Parameter Tuning:

With reference again to FIG. 3A, element 300 specifically shows the selection of values of l-parameters and u-parameters corresponding to equations (2)-(3) using hourly observed throughput, adjusted predictions by the described methods, and TSA forecasts. Three different types of models are explored in the cross-validation process: general, daily, and hourly.

The general model restricts the cross-validation process to use the same lower and upper bounds within the interval [0, 2] for the entire period of analysis. The daily model is more relaxed, restricting the model to use the same bounds within a day but allowing different values for different days, if needed. The hourly model allows the cross-validation process to chose the best bounds for each hour of a day.

Notably, there is depicted at SSCP A (element 304A) and SSCP B (element 304B) the general, daily, hourly, and TSA values utilized, all of which are summarized via the tables below. The Mean Absolute Error (MAE) is utilized as a measure of prediction quality, as depicted by Tables 1 and 2 below.

The box-plots shown summarize the parameter tuning results for SSCP A (element 304A) and SSCP B (element 304B), respectively. The general model has the smallest average error and spread of absolute error for SSCP A (element 304A), whereas the daily model is slightly better than the general model for SSCP B (element 304B). These models show an improvement in the average error compared with TSA projections, while the overall spread remains similar. The models with the smallest MAE in the predictions were selected.

Validation of Passenger Arrival Estimations—Back-Testing:

With reference next to FIG. 3B, element 301, the chart depicts the use of the proposed mechanistic and learning models to predict passenger arrivals. The data sources described above were utilized, including historical flight departure schedules from BTS Airline On-time Statistics (Bureau of Transport Statistics, 2019b) along with the above described parameter tuning results.

The graph depicted at SSCP A (element 305A) and SSCP B (element 305B), corresponding to the first observation of projections vs. observed throughput on a first date (e.g., date 1 at element 302) and the second observation of projections vs. observed throughput on a second date (e.g., date 2 at element 304 at FIG. 3C), show the mechanistic (elements 326 and 336) and adjusted projections (elements 327 and 337), as well as the observed passenger throughput per hour (e.g., via passenger volumes 329 and 339 over the hour of day at elements 330 and 340). In this case, the figures show that the adjustment process improves the mechanistic model for both SSCPs A (element 305A) and B (element 305B).

FIG. 3E depicts Table 1, which shows the MAE for the mechanistic, adjusted, and TSA predictions against observed throughput, according to described embodiments.

The adjusted mechanistic model presents the smallest error compared with the other prediction methods, with an average error of ˜112 and ˜109 passengers per hour in SSCPs A (element 305A) and B (element 305B), respectively. To put these numbers in perspective, Table 1 also shows in parenthesis the percentage of the MAE error relative to passenger volumes per hour from 7:00 am to 7:00 pm, which is the busiest period at Sky Harbor airport. Using this metric, the adjusted model shows the best performance for SSCP A (element 305A), whereas the TSA predictions show the smallest relative error for SSCP B (element 305B). This discrepancy led to the production of an ensemble model averaging the adjusted and TSA predictions. The last column of Table 1 reports the performance of this model, which turns out to be the model with the best prediction performance. This result may be due to the nature of the estimation models, where TSA predictions are mostly based on autoregressive-type calculations combining historical throughput and Secure Flight data, while the adjusted model relies on industry drivers.

Further explored were the quality of the models by calculating the MAE for those times where predictions underestimate the throughput. The motivation of this analysis comes from TSA operational decisions in which a short-staffed SSCP due to passenger underestimation is undesirable as it translates into long wait times.

FIG. 3F depicts Table 2, which shows that the ensemble model has the smallest average underestimation error for SSCP A (element 305A), accounting for a relative error of 7.6% of the passenger volume at busy times, according to described embodiments.

The mechanistic model presents the smallest error for SSCP B (element 305B) with a relative error of 3.9% of the passenger volume at the same times. However, it should be noted that the mechanistic model almost always overestimates passenger volumes. Depending on the analyst's preferences, the adjusted or ensemble model may offer a more balanced prediction error.

Forecasting Using Current Data:

As a second test, with reference again to FIG. 3C, the models were used to predict passenger volumes for the last three weeks of March. A realistic prediction exercise was recreated by only using data available in the first week of March (e.g., second date at element 304), including flight departure schedules from OAG. Quality of the models was again evaluated by calculating the MAE against observed (elements 345 and 355) throughput from TSA. As depicted here, SSCPs C (element 305C) and SSCPs D (element 305D) show the mechanistic (elements 346 and 356) and adjusted predictions (elements 347 and 357) for a first observed date in March (e.g., first date at element 302), as well as the observed passenger throughput per hour as depicted by passenger volumes (elements 349 and 359 over hour of day at elements 350 and 360). The improvement of the adjusted model over the mechanistic is clear for SSCP C (element 305C), but not so obvious for SSCP D (element 305D).

FIG. 3G depicts Table 3, which shows that the TSA prediction model performs better than the mechanistic and adjusted models for both SSCPs A (element 305A) and B (element 305B), according to described embodiments.

However, the ensemble model has the best predictive performance of all models for both terminals, with MAEs of ˜99 and ˜100 passengers per hour. The MAE relative to hourly passenger volumes for the ensemble model is equal to 15.9% and 17.5% for SSCPs A (element 305A) and B (element 305B), respectively.

FIG. 3H depicts Table 4, which shows the model performance when passenger arrivals are underestimated, where the best performance is given by the ensemble model for SSCP A (element 305A) and the mechanistic model for SSCP B (element 305B), according to described embodiments.

This result means that the mechanistic approach is overestimating most of the time. From Tables 3 and 4, it may be observed that the ensemble model has the best overall performance for both SSCPs A (element 305A) and B (element 305B).

FIG. 4 depicts the performance 400 of the ensemble model, in accordance with described embodiments.

In particular, use of the optimization models on a sample day is illustrated here, assuming that workforce allocation decisions need to be made in 10-minute intervals. As shown, by each of SSCP A at element 405A and SSCP B at element 405B, the 10-minute passenger predictions—i.e., λ-parameters in model equations (5)-(20)—using the results from above are depicted here. Moreover, parameters Lₜ=12, for all t=1, . . . , 24 and t=142, . . . , 144 (i.e., from midnight to 4:00 am and 11:40 pm to midnight) and Lₜ=40, for all t=25, . . . , 141 (i.e., from 4:00 am to 11:40 pm) and T are defined as the set of all 10-minute intervals within a day as depicted at element 410 on the horizontal axis with the passenger volume depicted on the vertical axis.

Further assumed is that B=30, meaning that no more than 30 flexible TSOs can be assigned to the SSCP in a day, beyond the baseline workforce of 45 TSOs. Flexible TSOs can be assigned to 4-hour shifts that can start at any time tϵT. A processing rate is used for each TDC of 360 passengers per hour and for each lane of 200 passengers per hour. Moreover, it is assumed that each open TDC stand is staffed with one TSO and each screening lane with five TSOs. These processing rates and workforce demands change linearly with the number of TDCs and screening lanes open. This can be easily modified to replicate any pattern given that the checkpoint configurations are enumerated in advance. The set of configurations consider that in any SSCP there is a maximum number of four TDC stations and eight screening lanes.

FIG. 5 depicts the optimal configuration 500 of each SSCP at the end of Stage 4, in accordance with described embodiments.

Specifically, the optimal configuration of each SSCP at the end of Stage 4 for each 10-minute interval of the chosen day is depicted. Element 505A depicts the number of screening lanes and TDCs for SSCP A while element 505B depicts the number of screening lanes and TDCs for SSCP B. These configurations include the optimal number of TDC stations and number of screening lanes open.

FIG. 6 depicts a graph 600 indicating the optimal starting time and number of flexible TSOs allocated to the SSCP as well as the predicted passenger arrivals, in accordance with described embodiments.

As expected, flexible TSOs and checkpoint reconfigurations anticipate the increase in passenger volume at busy times, e.g., at t=42 (7:00 am). This graph 600 shows that it is optimal to proactively open TDCs and screening lanes (with their corresponding flexible TSOs) before peak times to prevent queue buildup.

FIG. 7 depicts charts 700 showing the queue lengths at the end of Stage 1 (top at element 705A) and Stage 4 (bottom at element 705A) of each SSCP at the end of Stage 4, in accordance with described embodiments.

As expected, queue lengths after Stage 1 are not a minimum at every time, given that the objective at this stage is to minimize the maximum length. At the end of Stage 4, queue lengths are minimized without deteriorating the maximum queue length from Stage 1. In this case, the optimal SSCP configurations shown in FIG. 5 and flexible TSO allocations in FIG. 6(a) result in a maximum queue length of no more than 55 passengers per time.

FIG. 8 depicts charts 800 comparing the maximum wait time (i.e., K*-values) at the end of Stages 1 and 2, in accordance with described embodiments.

As expected, the maximum time in queue is not necessarily a minimum at the end of Stage 1, as the model focuses on minimizing the maximum queue length. The results from Stage 2 show that, in this case, the SSCP configurations are such that all queues are cleared in one period, guaranteeing a total maximum service time at the SSCP of 20 minutes (i.e., time at the TDC and screening lanes). This four-stage procedure is executed in no more than 5 minutes in a Dell Precision laptop with Intel Core i7 2.7 GHz and 16 GB of RAM. Experiments explored the sensitivity of the optimal SSCP performance to changes in the number of available flexible TSOs.

Intuitively, the maximum queue length of 55 passengers in FIG. 7 could be improved if more TSOs are available to operate more TDCs and screening lanes at peak times. FIG. 6(b) shows the impact of increasing the maximum number of flexible TSOs during the day on the maximum queue length. The non-smoothness in the sensitivity profile is because adding one additional TSO may not have a huge impact in the SSCP performance as it can only be assigned to a TDC duty. Adding more TSOs allows the model to open new screening lanes, each of which requires five TSOs. FIG. 6(b) also shows that there is a minimum (nonzero) queue length due to the fact that only a maximum number of eight screening lanes and four TDCs can be open at any time.

FIG. 9 depicts charts 900 indicating the optimal SSCP configurations after imposing the operational constraints at equations (21)-(24), in accordance with described embodiments.

In this case, two scenarios are depicted, requiring a configuration to be in operation for at least 30 (i.e., M=2) and 60 (i.e., M=5) consecutive minutes if selected. Although these new constraints reflect real SSCP operations, the lack of flexibility to reconfigure the SSCP deteriorates the overall queue performance. This can be seen by examining the maximum queue length, which increases from 55 passengers in the solution shown in FIG. 5, to 60 passengers when M=2 and 76 passengers when M=5. Moreover, imposing the Constraints of equations (21)-(24) implies at a higher computational cost, requiring 2.2 hours and 1.5 hours to solve the Stage 1 for M=2 and M=5, respectively, in a Dell Precision laptop with Intel Core i7 2.7 GHz and 16 GB of RAM. The consecutive stages are faster and take anywhere between 3 and 30 minutes.

The exemplary models described herein therefore operate to improve any airport's SSCP operations by providing more accurate passenger arrival predictions and a flexible modeling approach to decide optimal checkpoint configurations and their corresponding workforce allocations. The described models can be used to support other types of decisions such as TSO reallocations and hiring (number and schedule), SSCP expansions, and new screening technology acquisition to improve passenger processing rates (i.e., r-parameters). In practice, the described models provide evidence that proactive queue management is critical to prevent long queues and wait times, as they prevent queue buildups before peaks in demand.

Consequently, SSCP re-configuration decisions with their corresponding workforce allocations are critical to maintain short queues and must be executed before expected surges in passenger volumes. The described prediction and optimization models provide the following insights for TSA analysts to improve the efficiency of security checkpoint operations, including (1) Ensemble models can capture many aspects of the passenger arrival process (e.g., long- and short-term dynamics) and also reduce the error of the predictions, with experimental results indicating that in this case, having a suite of models of different nature is more advantageous than a single-model prediction; (2) Checkpoint re-configurations to increase processing rates must be executed before drastic increases in passenger arrivals, demonstrating that proactive queue management is more efficient than a reactive policy in which the SSCP configuration is adjusted only when queues are already long, with drastic changes in passenger arrivals being foreseeable by both the proposed prediction model and other airport signals such as a surge in curb drop-offs or congested baggage check-in areas; (3) Increasing the number of TSOs helps to improve the SSCP performance, but their impact depends on the locations where officers are added, for instance, adding a single TSO only allows for one more TDC station to be opened, whereas adding three to five TSOs allows for a new screening lane (depending on the lanes already opened) and further depending on the current SSCP configuration, it may be more beneficial to open a new screening lane rather than a TDC stand (refer again to FIGS. 5 and 9 which show that most of the time it is optimal to have fewer TDC stations open than screening lanes, with the former being equal or larger in number for a few time periods during or before high-volume arrivals; and (4) Resource flexibility can improve the SSCP operation, such that having flexible TSOs not only helps reduce queue lengths and wait times during passenger surges, but also provides a backup in case of unexpected passenger arrivals (e.g., due to last minute re-scheduled flights). For instance, FIG. 6(a) shows that flexible TSOs are used before as well as during high-volume arrival periods in addition to the TSOs already on duty. Moreover, layout flexibility that allows for quick opening and closing of screening lanes and TDCs can result in a more dynamic queue management.

FIG. 10 illustrates a diagrammatic representation of a machine 1001 in the exemplary form of a computer system, in accordance with one embodiment, within which a set of instructions, for causing the machine/computer system 1001 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1001 includes a processor 1002, a main memory 1004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1018 (e.g., a persistent storage device including hard disk drives and a persistent database and/or a multi-tenant database implementation), which communicate with each other via a bus 1030. Main memory 1004 includes various specialized components and computing architecture circuitry including the TSA input interface GUI 1024 (e.g., via which security personnel may input actual or hypothetical security multi-station and multi-stage screening zone data parameters for processing via the analytical model), the tunable model parameters interface GUI 1023 (e.g., via which security personnel may configure and customize the manner in which the specialized analytical model's algorithm will process input data), and the analytical model predictive outputs 1025 generated by the VADSS platform's specialized algorithm as applied by the VADSS platform's analytical model, for use with processing relevant security input data in support of the methodologies and techniques described herein. Main memory 1004 and its sub-elements are further operable in conjunction with processing logic 1026 and processor 1002 to perform the methodologies discussed herein.

Processor 1002 represents one or more specialized and specifically configured processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application-specific integrated circuit (ASIC), a field programmable gate array (FPGA), a digital signal processor (DSP), network processor, or the like. Processor 1002 is configured to execute the processing logic 1026 for performing the operations and functionality which is discussed herein.

The computer system 1001 may further include a network interface card 1008. The computer system 1001 also may include a user interface 1010 (such as a video display unit, a liquid crystal display, etc.), an alphanumeric input device 1012 (e.g., a keyboard), a cursor control device 1013 (e.g., a mouse), and a signal generation device 1016 (e.g., an integrated speaker). The computer system 1001 may further include peripheral device 1036 (e.g., wireless or wired communication devices, memory devices, storage devices, audio processing devices, video processing devices, etc.).

The secondary memory 1018 may include a non-transitory machine-readable storage medium or a non-transitory computer readable storage medium or a non-transitory machine-accessible storage medium 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1001, the main memory 1004 and the processor 1002 also constituting machine-readable storage media. The software 1022 may further be transmitted or received over a network 1020 via the network interface card 1008.

According to a particular embodiment, there is a Visual Analytics and Decision Support System platform (VADSS platform), including: a memory to store instructions; a processor to execute instructions stored in the memory; a parameter input interface to receive observed wait times and queue lengths at multi-station and multi-stage screening zones; a configuration interface to receive user specified configuration selections for processing the wait times and queue lengths; an analytical model to apply a specialized algorithm to yield future predicted wait times and queue lengths at the multi-station and multi-stage screening zones based at least in part on the observed wait times and queue lengths and the user specified configuration selections; in which the processor executes the instructions stored in the memory to cause the analytical model to accept the observed wait times and queue lengths as initial starting conditions and to incrementally update queue lengths at each stage to the start of the next period by adding any arrivals during a previous period and subtracting throughput for the respective stage based on the number of customers served; and in which the processor executes the instructions stored in the memory to cause the analytical model to further sequentially process each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and in which the processor executes the instructions stored in the memory to cause the analytical model to further compute and output the predicted wait time for any passenger by progressing that passenger on a first-come first-served manner through the network of service queues affiliated with each of the multi-station and multi-stage screening zones.

FIGS. 11A and 11B depict flow diagrams illustrating a method 1100 and 1101 for evaluating wait times and queue lengths at multi-station and multi-stage screening zones via a deterministic decision support algorithm, in accordance with disclosed embodiments. Method 1100 and 1101 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, the machine 1001 (see FIG. 10) and the other supporting systems and components as described herein may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 1100 depicted at FIG. 11A beginning at block 1105, there is a method performed by a Visual Analytics and Decision Support System platform (VADSS platform) having at least a processor and a memory therein for evaluating wait times and queue lengths at multi-station and multi-stage screening zones via a deterministic decision support algorithm, in which the method includes the following operations:

At block 1110, processing logic receives, via a parameter input interface, observed wait times and queue lengths at multi-station and multi-stage screening zones.

At block 1115, processing logic receives, via a configuration interface, user specified configuration selections for processing the wait times and queue lengths.

At block 1120, processing logic applies a specialized algorithm via an analytical model to yield future predicted wait times and queue lengths at the multi-station and multi-stage screening zones based at least in part on the observed wait times and queue lengths and the user specified configuration selections.

Transitioning to the continuation of method 1100, processing advances to FIG. 11B, where method 1101 and specifically block 1125 includes processing logic indicates the analytical model accepts the observed wait times and queue lengths as initial starting conditions and incrementally updates queue lengths at each stage to the start of the next period by adding any arrivals during a previous period and subtracting throughput for the respective stage based on the number of customers served.

At block 1130, processing logic indicates the analytical model further sequentially processes each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full.

At block 1135, processing logic indicates the analytical model computes and outputs the predicted wait time for any passenger by progressing that passenger on a first-come first-served manner through the network of service queues affiliated with each of the multi-station and multi-stage screening zones.

According to another embodiment, method 1100-1101 further includes: exploring a hypothetical “what if” scenario created by an end user by: receiving manually adjusted input parameters at the parameter input interface, overriding the observed wait times and queue lengths at the multi-station and multi-stage screening zones; processing the manually adjusted input parameters via the specialized algorithm of the analytical model to output new predicted wait times and queue lengths at the multi-station and multi-stage screening zones; and displaying the new predicted wait times and queue lengths in fulfillment of the hypothetical “what if” scenario created by the end user.

According to another embodiment of method 1100-1101, the VADSS platform assumes a first-come, first-service queue discipline.

According to another embodiment of method 1100-1101, the specialized algorithm applied by the VADSS platform is deterministic, providing point estimates.

According to another embodiment of method 1100-1101, the specialized algorithm applied by the VADSS platform applies a defined methodology for converting a dynamic forecast of expected arrivals and staffing levels into forecasts of queue lengths that will occur at each stage of the multi-station and multi-stage screening zones.

According to another embodiment of method 1100-1101, the specialized algorithm applied by the VADSS platform applies a defined means for converting the observed queue lengths and wait times into an estimated throughput for each stage of the multi-station and multi-stage screening zones.

According to another embodiment of method 1100-1101, the specialized algorithm applied by the VADSS platform generates as its output, a set of tabular and graphical interface displays with predicted future performance of the overall security screening system made up of the multi-station and multi-stage screening zones.

According to another embodiment of method 1100-1101, the specialized algorithm applied by the VADSS platform optionally adds probabilistic visits to workstations such as secondary screening when configured by the user via the user specified configuration selections.

According to another embodiment of method 1100-1101, the specialized algorithm applied by the VADSS platform reduces the queue in front of any arriving customer at any stage (workstation) based on that stage's effective processing rate until the time interval in which the passenger's leading queue reaches zero.

According to another embodiment of method 1100-1101, the specialized algorithm applied by the VADSS platform applies interpolation within the last period to determine a final throughput time.

According to another embodiment of method 1100-1101, the specialized algorithm applied by the VADSS platform sums the wait times for each stage of multi-station and multi-stage screening zones multiplied by the probability of a passenger visiting that station.

According to a particular embodiment, there is a non-transitory computer readable storage media having instructions stored thereupon that, when executed by a Visual Analytics and Decision Support System platform (VADSS platform) having at least a processor and a memory therein, the instructions cause the VADSS platform to perform operations including: receiving, via a parameter input interface, observed wait times and queue lengths at multi-station and multi-stage screening zones; receiving, via a configuration interface, user specified configuration selections for processing the wait times and queue lengths; applying a specialized algorithm via an analytical model to yield future predicted wait times and queue lengths at the multi-station and multi-stage screening zones based at least in part on the observed wait times and queue lengths and the user specified configuration selections; in which the analytical model accepts the observed wait times and queue lengths as initial starting conditions and incrementally updates queue lengths at each stage to the start of the next period by adding any arrivals during a previous period and subtracting throughput for the respective stage based on the number of customers served; in which the analytical model further sequentially processes each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and in which the analytical model computes and outputs the predicted wait time for any passenger by progressing that passenger on a first-come first-served manner through the network of service queues affiliated with each of the multi-station and multi-stage screening zones.

FIGS. 12A and 12B depict flow diagrams illustrating a method 1200 and 1201 for computing passenger arrival estimations and optimal Transportation Security Officer (TSO) allocation within a multi-station and multi-stage security screening area having a plurality of Security Screening Checkpoints (SSCPs), in accordance with disclosed embodiments. Method 1200 and 1201 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, the machine 1001 (see FIG. 10) and the other supporting systems and components as described herein may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 1200 depicted at FIG. 12A beginning at block 1205, there is a method performed by executing a system for computing passenger arrival estimations and optimal Transportation Security Officer (TSO) allocation within a multi-station and multi-stage security screening area having a plurality of Security Screening Checkpoints (SSCPs), by performing the following operations:

At block 1210, processing logic retrieves a business fundamentals data set defining one or more of flight departure schedules, airplane capacities, and expected number of passengers.

At block 1215, processing logic executes a mechanistic model to generate a mechanistic prediction indicating a quantity of passenger arrivals based on business fundamentals data set.

At block 1220, processing logic retrieves a number of screened passengers as a proxy for the quantity of observed passenger arrivals at each SSCP.

Transitioning to the continuation of method 1200, processing advances to FIG. 12B, where method 1201 and specifically block 1225 includes processing logic which estimates a set of adjusting factors for the proxy by minimizing the sum of squared errors between the mechanistic prediction previously generated and the proxy for the quantity of observed passenger arrivals to prevent over-fitting.

At block 1230, processing logic executes a time series auto-regressive model to predict passenger volumes based on historical data by applying machine learning to adjust the mechanistic prediction indicating the quantity of passenger arrivals using the set of adjusting factors and based further on the historical data for the day of week, week of year and time of day.

At block 1235, processing logic assigns TSOs to one or more of the SSCPs based on the passenger volumes predicted.

According to another embodiment of method 1200-1201, executing a time series auto-regressive model to predict passenger volumes comprises combining the estimated set of adjusting factors with a time series analysis model built on the historical data for the day of week, week of year and time of day.

According to another embodiment, method 1200-1201 further includes: retrieving a historical fundamentals data set defining one or more of historical flight departure schedules, historical airplane capacities, and historical number of passengers serviced; and training a learning model to improve the mechanistic prediction generated by the mechanistic model using adjusting factors obtained from a training set having the historical fundamentals data set represented therein.

According to another embodiment of method 1200-1201, the proxy is defined by a quantity of passengers having passed through an Advanced Imaging Technology (AIT) full body scanner or a Walk Through Metal Detector (WTMD) at any of the SSCPs.

According to another embodiment of method 1200-1201, assigning the TSOs to one or more of the SSCPs based on the passenger volumes predicted, further includes: combining the passenger volumes predicted with data specifying the number of available TSOs per time interval; and allocating TSO teams to open Travel Document Check (TDC) and Baggage Screening lanes in Pre-Check and Standard lines of the multi-station and multi-stage security screening area to minimize passenger queue lengths and wait times.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A Visual Analytics and Decision Support System platform (VADSS platform), comprising:
a memory to store instructions;
a processor to execute instructions stored in the memory;
a parameter input interface to receive observed wait times and queue lengths at multi-station and multi-stage screening zones;
a configuration interface to receive user specified configuration selections for processing the wait times and queue lengths;
an analytical model to apply a specialized algorithm to yield future predicted wait times and queue lengths at the multi-station and multi-stage screening zones based at least in part on the observed wait times and queue lengths and the user specified configuration selections;
wherein the processor executes the instructions stored in the memory to cause the analytical model to accept the observed wait times and queue lengths as initial starting conditions and to incrementally update queue lengths at each stage to the start of the next period by adding any arrivals during a previous period and subtracting throughput for the respective stage based on the number of customers served; and
wherein the processor executes the instructions stored in the memory to cause the analytical model to further sequentially process each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and
wherein the processor executes the instructions stored in the memory to cause the analytical model to further compute and output the predicted wait time for any passenger by progressing that passenger on a first-come first-served manner through the network of service queues affiliated with each of the multi-station and multi-stage screening zones.

2. The VADSS platform of claim 1, further comprising:
exploring a hypothetical “what if” scenario created by an end user by:
receiving manually adjusted input parameters at the parameter input interface, overriding the observed wait times and queue lengths at the multi-station and multi-stage screening zones;
processing the manually adjusted input parameters via the specialized algorithm of the analytical model to output new predicted wait times and queue lengths at the multi-station and multi-stage screening zones; and
displaying the new predicted wait times and queue lengths in fulfillment of the hypothetical “what if” scenario created by the end user.

3. The VADSS platform of claim 1, wherein the VADSS platform assumes a first-come, first-service queue discipline.

4. The VADSS platform of claim 1, wherein the VADSS platform generates the predicted wait times and queue lengths by converting a dynamic stream of customer arrivals and planned staffing levels for a multistage, parallel processor, finite queue, serial flow network into estimates of queue lengths and throughput times at each processing stage at each point in time.

5. The VADSS platform of claim 1, wherein the specialized algorithm applied by the VADSS platform is deterministic, providing point estimates.

6. The VADSS platform of claim 1, wherein the specialized algorithm applied by the VADSS platform applies a defined methodology for converting a dynamic forecast of expected arrivals and staffing levels into forecasts of queue lengths that will occur at each stage of the multi-station and multi-stage screening zones.

7. The VADSS platform of claim 1, wherein the specialized algorithm applied by the VADSS platform applies a defined means for converting the observed queue lengths and wait times into an estimated throughput for each stage of the multi-station and multi-stage screening zones.

8. The VADSS platform of claim 1, wherein the specialized algorithm applied by the VADSS platform generates as its output, a set of tabular and graphical interface displays with predicted future performance of the overall security screening system made up of the multi-station and multi-stage screening zones.

9. The VADSS platform of claim 1, wherein the specialized algorithm applied by the VADSS platform optionally adds probabilistic visits to workstations such as secondary screening when configured by the user via the user specified configuration selections.

10. The VADSS platform of claim 1, wherein the specialized algorithm applied by the VADSS platform reduces the queue in front of any arriving customer at any stage (workstation) based on that stage's effective processing rate until the time interval in which the passenger's leading queue reaches zero.

11. The VADSS platform of claim 1, wherein the specialized algorithm applied by the VADSS platform applies interpolation within the last period to determine a final throughput time.

12. The VADSS platform of claim 1, wherein the specialized algorithm applied by the VADSS platform sums the wait times for each stage of multi-station and multi-stage screening zones multiplied by the probability of a passenger visiting that station.

13. A method performed by a Visual Analytics and Decision Support System platform (VADSS platform) having at least a processor and a memory therein, wherein the method comprises:
receiving, via a parameter input interface, observed wait times and queue lengths at multi-station and multi-stage screening zones;
receiving, via a configuration interface, user specified configuration selections for processing the wait times and queue lengths;
applying a specialized algorithm via an analytical model to yield future predicted wait times and queue lengths at the multi-station and multi-stage screening zones based at least in part on the observed wait times and queue lengths and the user specified configuration selections;
wherein the analytical model accepts the observed wait times and queue lengths as initial starting conditions and incrementally updates queue lengths at each stage to the start of the next period by adding any arrivals during a previous period and subtracting throughput for the respective stage based on the number of customers served;
wherein the analytical model further sequentially processes each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and
wherein the analytical model computes and outputs the predicted wait time for any passenger by progressing that passenger on a first-come first-served manner through the network of service queues affiliated with each of the multi-station and multi-stage screening zones.

14. Non-transitory computer readable storage media having instructions stored thereupon that, when executed by a Visual Analytics and Decision Support System platform (VADSS platform) having at least a processor and a memory therein, the instructions cause the VADSS platform to perform operations including:
receiving, via a parameter input interface, observed wait times and queue lengths at multi-station and multi-stage screening zones;
receiving, via a configuration interface, user specified configuration selections for processing the wait times and queue lengths;
applying a specialized algorithm via an analytical model to yield future predicted wait times and queue lengths at the multi-station and multi-stage screening zones based at least in part on the observed wait times and queue lengths and the user specified configuration selections;
wherein the analytical model accepts the observed wait times and queue lengths as initial starting conditions and incrementally updates queue lengths at each stage to the start of the next period by adding any arrivals during a previous period and subtracting throughput for the respective stage based on the number of customers served;
wherein the analytical model further sequentially processes each of the stages of the multi-station and multi-stage screening zones to compute a number served at each stage during the time interval as the minimum of the service capacity based on (i) the number of service stations open and based further on (ii) a service rate per station provided by the user specified configuration selections, (iii) a number of initial customers in queue plus those arriving, and (iv) the service rate of the subsequent workstation when the subsequent station buffer space is full; and
wherein the analytical model computes and outputs the predicted wait time for any passenger by progressing that passenger on a first-come first-served manner through the network of service queues affiliated with each of the multi-station and multi-stage screening zones.

15. A system for computing passenger arrival estimations and optimal Transportation Security Officer (TSO) allocation within a multi-station and multi-stage security screening area having a plurality of Security Screening Checkpoints (SSCPs), wherein the system comprises:
a memory to store instructions;
a processor to execute instructions stored in the memory;
retrieving a business fundamentals data set defining one or more of flight departure schedules, airplane capacities, and expected number of passengers;
executing a mechanistic model to generate a mechanistic prediction indicating a quantity of passenger arrivals based on business fundamentals data set;
retrieving a number of screened passengers as a proxy for the quantity of observed passenger arrivals at each SSCP;
estimating a set of adjusting factors for the proxy by minimizing the sum of squared errors between the mechanistic prediction previously generated and the proxy for the quantity of observed passenger arrivals to prevent over-fitting;
executing a time series auto-regressive model to predict passenger volumes based on historical data by applying machine learning to adjust the mechanistic prediction indicating the quantity of passenger arrivals using the set of adjusting factors and based further on the historical data for the day of week, week of year and time of day; and
assigning TSOs to one or more of the SSCPs based on the passenger volumes predicted.

16. The method of claim 15, wherein executing a time series auto-regressive model to predict passenger volumes comprises combining the estimated set of adjusting factors with a time series analysis model built on the historical data for the day of week, week of year and time of day.

17. The method of claim 15, wherein the method further comprises:
retrieving a historical fundamentals data set defining one or more of historical flight departure schedules, historical airplane capacities, and historical number of passengers serviced; and
training a learning model to improve the mechanistic prediction generated by the mechanistic model using adjusting factors obtained from a training set having the historical fundamentals data set represented therein.

18. The method of claim 15, wherein the proxy is defined by a quantity of passengers having passed through an Advanced Imaging Technology (AIT) full body scanner or a Walk Through Metal Detector (WTMD) at any of the SSCPs.

19. The method of claim 1, wherein assigning the TSOs to one or more of the SSCPs based on the passenger volumes predicted, comprises:
combining the passenger volumes predicted with data specifying the number of available TSOs per time interval; and
allocating TSO teams to open Travel Document Check (TDC) and Baggage Screening lanes in Pre-Check and Standard lines of the multi-station and multi-stage security screening area to minimize passenger queue lengths and wait times.

20. A method performed by a system having at least a processor and a memory therein for computing passenger arrival estimations and optimal Transportation Security Officer (TSO) allocation within a multi-station and multi-stage security screening area having a plurality of Security Screening Checkpoints (SSCPs), wherein the method comprises:
retrieving a business fundamentals data set defining one or more of flight departure schedules, airplane capacities, and expected number of passengers;
executing a mechanistic model to generate a mechanistic prediction indicating a quantity of passenger arrivals based on business fundamentals data set;
retrieving a number of screened passengers as a proxy for the quantity of observed passenger arrivals at each SSCP;
estimating a set of adjusting factors for the proxy by minimizing the sum of squared errors between the mechanistic prediction previously generated and the proxy for the quantity of observed passenger arrivals to prevent over-fitting;
executing a time series auto-regressive model to predict passenger volumes based on historical data by applying machine learning to adjust the mechanistic prediction indicating the quantity of passenger arrivals using the set of adjusting factors and based further on the historical data for the day of week, week of year and time of day; and
assigning TSOs to one or more of the SSCPs based on the passenger volumes predicted.

21. Non-transitory computer readable storage media having instructions stored thereupon that, when executed by a system having at least a processor and a memory therein for computing passenger arrival estimations and optimal Transportation Security Officer (TSO) allocation within a multi-station and multi-stage security screening area having a plurality of Security Screening Checkpoints (SSCPs), the instructions cause the system to perform operations including:
retrieving a business fundamentals data set defining one or more of flight departure schedules, airplane capacities, and expected number of passengers;
executing a mechanistic model to generate a mechanistic prediction indicating a quantity of passenger arrivals based on business fundamentals data set;
retrieving a number of screened passengers as a proxy for the quantity of observed passenger arrivals at each SSCP;
estimating a set of adjusting factors for the proxy by minimizing the sum of squared errors between the mechanistic prediction previously generated and the proxy for the quantity of observed passenger arrivals to prevent over-fitting;
executing a time series auto-regressive model to predict passenger volumes based on historical data by applying machine learning to adjust the mechanistic prediction indicating the quantity of passenger arrivals using the set of adjusting factors and based further on the historical data for the day of week, week of year and time of day; and
assigning TSOs to one or more of the SSCPs based on the passenger volumes predicted.
